(19) United States
(12) Patent Application Publication
(10) Pub. No.: US 2024/0046704 A1
(43) Pub. Date: Feb. 8, 2024

(54) DETERMINATION METHOD AND DETERMINATION APPARATUS

(71) Applicants: Fujitsu Limited, Kawasaki-shi (JP); Inter-University Research Institute Corporation Research Organization of Information and Systems, Tokyo (JP)

(72) Inventors: Mingxie Zheng, Kawasaki (JP); Jun Takahashi, Kawasaki (JP); Toshiyuki Yoshitake, Kawasaki (JP); Masayoshi Shimizu, Hadano (JP); Isao Echizen, Chiyoda (JP)

(73) Assignees: Fujitsu Limited, Kawasaki-shi (JP); Inter-University Research Institute Corporation Research Organization of Information and Systems, Tokyo (JP)

(21) Appl. No.: 18/332,351

(22) Filed: Jun. 9, 2023

(30) Foreign Application Priority Data
Aug. 4, 2022 (JP) 2022-124896

(51) Int. Cl. G06V 40/20; G06V 10/74

(52) U.S. Cl. CPC G06V 40/20; G06V 10/761

(57) ABSTRACT

A determination apparatus calculates, based on a first data group which includes data indicating behaviors of people, reference behavior data indicating a reference behavior among the people about each of a plurality of types of behaviors, acquires, from the first data group, first behavior data indicating a behavior of a first person about each behavior type, calculates difference between the first behavior data and the reference behavior data about each behavior type, determines, from the plurality of types, at least one first type whose difference is at least a first threshold, registers second behavior data indicating a behavior of the first person about each first type in a second data group, extracts third behavior data indicating a behavior of a second person from an input image, and determines whether the second person is identical with the first person based on comparison between the third and second behavior data.

### CROSS-REFERENCE TO RELATED APPLICATION

This application is based upon and claims the benefit of priority of the prior Japanese Patent Application No. 2022-124896, filed on Aug. 4, 2022, the entire contents of which are incorporated herein by reference.

### FIELD

The embodiments discussed herein relate to a determination method and a determination apparatus.

### BACKGROUND

In recent years, fake images, especially fake images of people, have been generated by using deep learning technology, and misuse of these fake images has become a problem. These fake images are high-quality images, and it is difficult to determine that these images are fake at first glance.

To solve this problem, there has been proposed a technique of comparing a behavior of a person detected from a previously captured image with a behavior of a person detected from a newly entered image and determining whether these people are the same person. For example, there has been proposed a remote communication system for determining the identity of a participant in an ongoing communication, based on a result of the comparison between reference behavior information based on past characteristic behaviors of participants in the remote communication system and present behavior information based on characteristic behaviors of the participant in the ongoing communication.

There has also been proposed a person recognition system relating to image recognition. In this person recognition system, for example, information indicating states of individual portions of a face of a recognition target person is detected from a plurality of captured images. Next, the information is arranged per portion in chronological order. Finally, whether the information per portion is recognized as the motion per portion of the face of an actual person is determined based on previously registered motion patterns of the individual portions.

For example, see Japanese Patent No. 6901190 and Japanese Laid-open Patent Publication No. 2008-71179.

### SUMMARY

According to one aspect, there is provided a non-transitory computer-readable recording medium storing therein a computer program that causes a computer to execute a process including: calculating, based on a first data group in which data indicating a plurality of types of behaviors of each of a plurality of people is registered, reference behavior data indicating a reference behavior among the plurality of people about each of the plurality of types of behaviors; acquiring, from the first data group, first behavior data indicating a behavior of a first person among the plurality of people about the each of the plurality of types; calculating a difference between the first behavior data and the reference behavior data about the each of the plurality of types; determining, from the plurality of types, at least one first type which has the difference equal to or greater than a first threshold and registering second behavior data indicating a behavior of the first person about each of the at least one first type in a second data group; extracting third behavior data indicating a behavior of a second person from an input image; and determining whether the second person is identical with the first person based on a result of a comparison between the third behavior data and the second behavior data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a process performed by a determination apparatus according to a first embodiment;

FIG. 2 illustrates an example of a configuration of a video communication system according to a second embodiment;

FIG. 3 illustrates an example of a hardware configuration of a control server;

FIG. 4 illustrates an example of a configuration of a basic processing function of the control server;

FIG. 5 illustrates a comparison example of an impersonation determination method;

FIGS. 6A and 6B illustrate behaviors that are characteristic of a person;

FIG. 7 illustrates an example of a configuration of a processing function of a control server according to embodiment 2-1;

FIG. 8 is an example of a flowchart illustrating a procedure of a behavior extraction process performed by a behavior extraction unit;

FIG. 9 illustrates a data structure example of a time-series feature value;

FIG. 10 is an example of a flowchart illustrating a procedure of a behavior determination process performed by a behavior determination unit;

FIG. 11 illustrates a data structure example of a behavior database;

FIG. 12 is an example of a flowchart illustrating a procedure of a reference behavior definition process performed by a reference behavior definition unit;

FIG. 13 illustrates a data structure example of a reference behavior database;

FIG. 14 is an example of a flowchart illustrating a procedure of a behavior difference calculation process performed by a behavior difference calculation unit;

FIG. 15 illustrates a data structure example of a behavior difference database;

FIG. 16 is an example of a flowchart illustrating a procedure of a determination feature value calculation process performed by a determination feature value calculation unit;

FIG. 17 illustrates a data structure example of a determination feature value database;

FIG. 18 is an example of the first half of a flowchart illustrating a procedure of an impersonation determination process performed by an impersonation determination unit;

FIG. 19 is an example of the second half of the flowchart illustrating the procedure of the impersonation determination process performed by the impersonation determination unit;

FIG. 20 illustrates an example of a determination result display screen;

FIG. 21 illustrates an example of a configuration of a processing function of a control server according to embodiment 2-2;

FIG. 22 illustrates an impersonation determination method according to embodiment 2-2;

FIG. 23 conceptually illustrates a process for determining behaviors constantly exhibited by a person;

FIG. 24 illustrates a calculation example of a behavior variation range;

FIG. 25 conceptually illustrates a determination feature value selection process;

FIG. 26 illustrates a calculation example of a feature value difference value;

FIG. 27 is an example of a flowchart illustrating a procedure of a personal behavior determination process performed by a personal behavior determination unit;

FIG. 28 illustrates a data structure example of a personal behavior database;

FIG. 29 is an example of a flowchart illustrating a procedure of a reference behavior definition process according to embodiment 2-2;

FIG. 30 is an example of a flowchart illustrating a procedure of a behavior difference calculation process according to embodiment 2-2;

FIG. 31 illustrates a configuration example of a processing function of a control server according to embodiment 2-3; and

FIG. 32 is an example of a flowchart illustrating a procedure of an impersonation determination process according to embodiment 2-3.

### DESCRIPTION OF EMBODIMENTS

As described above, in one method for determining the identity of a person, the feature values of past behaviors of the person are compared with the feature values of present behaviors of the person, about a plurality of predetermined types of behaviors. However, in this method, the comparison could be performed not only on the behaviors that are characteristic of this person but also on other behaviors that are similar to those of other people. Therefore, for example, an impersonator could erroneously be determined to be the authentic person.

Hereinafter, the embodiments will be described with reference to the drawings.

### First Embodiment

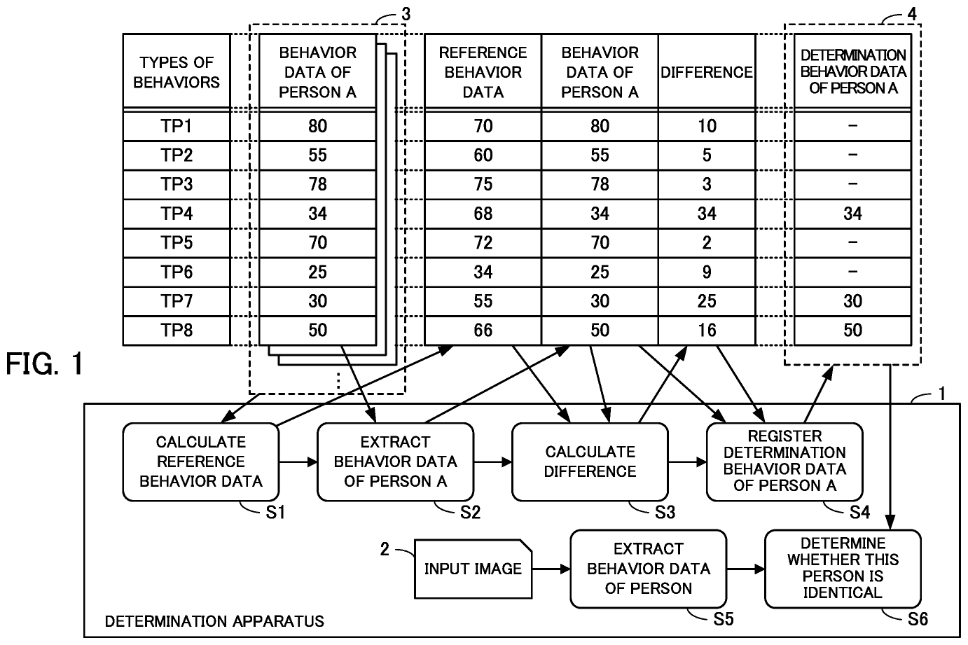

FIG. 1 illustrates an example of a process performed by a determination apparatus according to a first embodiment. This determination apparatus 1 illustrated in FIG. 1 determines whether a person included in an input image 2 is identical with a predetermined person (authentic person). The determination apparatus 1 is, for example, a computer including a processor and a memory. In this case, at least part of the process performed by the determination apparatus 1 is implemented by causing the processor to execute a predetermined program.

The following description will be made based on an example in which the determination apparatus 1 determines whether the person included in the input image 2 is a person A. First, the determination apparatus 1 generates data used for this determination in accordance with the following procedure.

The determination apparatus 1 calculates, based on a data group 3 in which data indicating a plurality of types of behaviors of each of a plurality of people including the person A is registered, reference behavior data indicating a reference behavior among the plurality of people about each of the plurality of types of behaviors (step S1). In the example in FIG. 1, the behaviors are classified into eight types TP1 to TP8, and behavior data about each of the types TP1 to TP8 is registered in the data group 3. For example, the individual behavior data includes at least one image feature value determined for the corresponding behavior type. In FIG. 1, for ease of description, the individual behavior data is represented by an integer between 0 and 100, inclusive. The individual reference behavior data indicates an average feature value among the plurality of people about one type of behavior and is calculated as an intermediate value or an average value of the corresponding behavior data of the plurality of people, for example.

Next, the determination apparatus 1 acquires, from the data group 3, the behavior data of the person A about each of the types TP1 to TP8 (step S2). Next, the determination apparatus 1 calculates the difference between the behavior data of the person A and the reference behavior data about each of the types TP1 to TP8 (step S3). For example, the determination apparatus 1 calculates the difference “10” between the behavior data “80” of the person A about the type TP1 and the reference behavior data “70” about the type TP1. In addition, the determination apparatus 1 calculates the difference “5” between the behavior data “55” of the person A about the type TP2 and the reference behavior data “60” about the type TP2.

Next, the determination apparatus 1 determines, from the types TP1 to TP8, at least one type, about which the difference is equal to or greater than a predetermined threshold, and registers the behavior data of the person A about each of the at least one type determined in a data group 4 as determination behavior data (step S4). The example in FIG. 1 assumes that the threshold is “15” and that the types TP4, TP7, and TP8 have been determined as the determined types. In this case, the determination apparatus 1 registers the behavior data “34” of the person A about the type TP4, the behavior data “30” of the person A about the type TP7, and the behavior data “50” of the person A about the type TP8 in the data group 4 as the determination behavior data. The individual behavior data registered is associated with a corresponding type identification number.

The determination behavior data of the person A is registered in the data group 4 in this way, and the determination apparatus 1 performs its determination process by referring to the data group 4. The determination apparatus 1 extracts behavior data indicating a behavior of a person from the input image 2 (step S5). In this process, behavior data indicating a behavior of at least one of the types TP1 to TP8 is extracted. Next, the determination apparatus 1 compares the extracted behavior data with the determination behavior data registered per type in the data group 4 and determines whether the person on the input image 2 is identical with the person A based on a result of the comparison (step S6).

For example, the determination apparatus 1 extracts, from the input image 2, behavior data indicating the behaviors about the types TP2, TP3, TP4, and TP7 in step S5. However, no determination behavior data about the types TP2 and TP3 is registered in the data group 4. Thus, the determination apparatus 1 performs the comparison only about the types TP4 and TP7 in step S6.

The following example assumes that the behavior data about the type TP4 indicates “40” and the behavior data about the type TP7 indicates “35”. In this case, the determination apparatus 1 calculates the difference “6” between the behavior data “40” and the determination behavior data “34” about the type TP4 and calculates the difference “5” between the behavior data “35” and the determination behavior data “30” about the type TP7, for example. If the threshold is “10”, either of the differences is less than the threshold. Thus, the determination apparatus 1 determines that the newly entered behaviors match the behaviors indicated by the determination behavior data about the types TP4 and TP7. For example, if the determination apparatus 1 has been configured to determine that a first person is the same as a second person when at least two types of behaviors match, this determination apparatus 1 determines that the person on the input image 2 is the same as the person A in the above example.

There are some types of behaviors that a plurality of people exhibit in a similar way. For example, a lot of people exhibit behaviors such as raising a hand and nodding in a similar way. Thus, about such a behavior, not a significant difference is detected between the behavior data of an individual person and the corresponding reference behavior data. Thus, if these types of behavior data similar among people are used for the comparison in step S6, the probability that an impersonator will erroneously be determined to be the authentic person is increased. In contrast, it is fair to say that a type of behavior about which the difference between the past behavior data of a person and the corresponding reference behavior data is large is a behavior that is characteristic of this person (a characteristic behavior). Thus, by using only these types of behavior data for the comparison in step S6, the possibility of occurrence of an erroneous determination is reduced.

The determination behavior data registered in the data group 4 indicates types of behaviors. About each of these types, the difference between the past behavior data of the person A and the corresponding reference behavior data is large (that is, types of behaviors of the person A that significantly differ from those of other people). Thus, as described above, by performing the comparison in step S6 by using only the types of behavior data registered in the data group 4 of all the behavior data extracted from the input image 2, whether the person on the input image 2 is the person A is accurately determined.

### Second Embodiment

The following description will be made on a video communication system that performs impersonation determination by using the processing function of the determination apparatus 1 in FIG. 1.

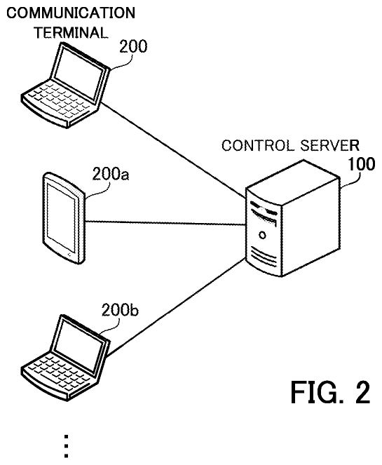

FIG. 2 illustrates an example of a configuration of a video communication system according to a second embodiment. The video communication system illustrated in FIG. 2 includes a control server 100 and communication terminals 200, 200a, 200b, etc.

The control server 100 is an example of the determination apparatus 1 illustrated in FIG. 1. This control server 100 controls a video communication between communication terminals. For example, when a video communication is performed between the communication terminals 200a and 200b, the control server 100 receives the voice picked up by the communication terminal 200a and the image captured by the communication terminal 200a and transmits the voice and image to the communication terminal 200b. In addition, the control server 100 receives the voice picked up by the communication terminal 200b and the image captured by the communication terminal 200b and transmits the voice and image to the communication terminal 200a.

In addition, the control server 100 performs an impersonation determination process for determining whether a person included in an image transmitted from a communication terminal is authentic. To perform this impersonation determination process, the control server 100 accumulates images received from the communication terminals 200, 200a, 200b, etc., performing communications and creates, based on the accumulated images, data that the control server 100 refers to when performing the impersonation determination process.

The communication terminals 200, 200a, 200b, etc., are each a terminal apparatus used by a person who performs a video communication and are each a personal computer, such as a laptop computer or a desktop computer, or a smartphone, for example. The communication terminals 200, 200a, 200b, etc., are each equipped with or connected to devices such as a microphone, a camera, a speaker, and a display. One of the communication terminals between which a video communication is performed transmits the voice picked up by its microphone and the image captured by its camera to the control server 100. In addition, this communication terminal receives the voice picked up by the other communication terminal and the image captured by the other communication terminal from the control server 100, outputs the received voice from its speaker, and displays the received image on its display.

The video communication system may be a system that enables a video communication among three or more communication terminals.

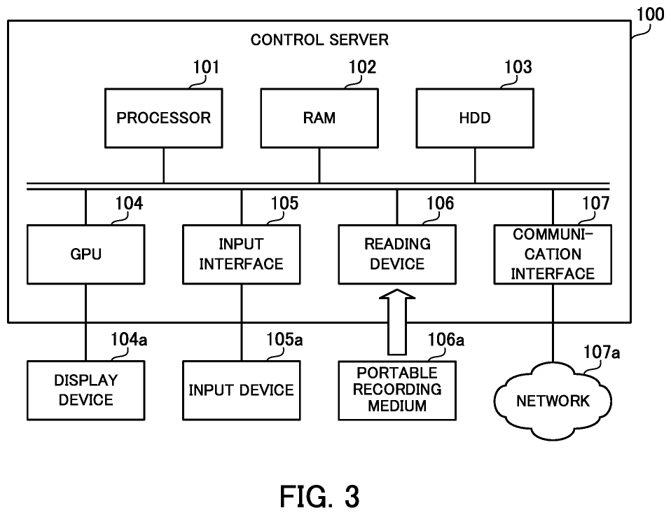

FIG. 3 illustrates an example of a hardware configuration of the control server. The control server 100 may be a computer as illustrated in FIG. 3, for example. The control server 100 illustrated in FIG. 3 includes a processor 101, a random-access memory (RAM) 102, a hard disk drive (HDD) 103, a graphics processing unit (GPU) 104, an input interface 105, a reading device 106, and a communication interface 107.

The processor 101 comprehensively controls the control server 100. The processor 101 is, for example, a central processing unit (CPU), a micro processing unit (MPU), a digital signal processor (DSP), an application specific integrated circuit (ASIC), or a programmable logic device (PLD). Alternatively, the processor 101 may be a combination of at least two of a CPU, an MPU, a DSP, an ASIC, and a PLD.

The RAM 102 is used as a main storage device of the control server 100. The RAM 102 temporarily stores at least part of an operating system (OS) program or an application program executed by the processor 101. In addition, the RAM 102 stores various kinds of data that is needed for processes performed by the processor 101.

The HDD 103 is used as an auxiliary storage device of the control server 100. The HDD 103 stores an OS program, an application program, and various kinds of data. As the auxiliary storage device, a different kind of non-volatile storage device such as a solid-state drive (SSD) may be used.

The GPU 104 is connected to a display device 104a. The GPU 104 displays images on the display device 104a in accordance with instructions from the processor 101. For example, a liquid crystal display, an organic electroluminescence (EL) display, or the like is used as the display device 104a.

The input interface 105 is connected to an input device 105a. The input interface 105 transmits signals outputted from the input device 105a to the processor 101. Examples of the input device 105a include a keyboard and a pointing device. A mouse, a touch panel, a tablet, a touch pad, a track ball, or the like is used as the pointing device.

A portable recording medium 106a is attachable to and detachable from the reading device 106. The reading device 106 reads data stored in the portable recording medium 106a and transmits the read data to the processor 101. Examples of the portable recording medium 106a include an optical disc and a semiconductor memory.

The communication interface 107 exchanges data with other apparatuses such as the communication terminals 200, 200a, and 200b via a network 107a.

The processing function of the control server 100 may be implemented by using the above hardware configuration. Each of the communication terminals 200, 200a, 200b, etc., may also be a computer including a processor, a main storage device, an auxiliary storage device, etc.

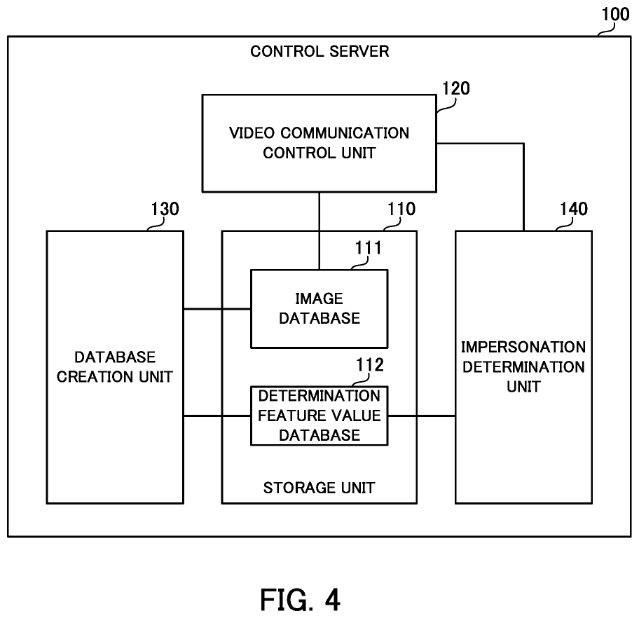

FIG. 4 illustrates an example of a configuration of a basic processing function of the control server. As illustrated in FIG. 4, the control server 100 includes a storage unit 110, a video communication control unit 120, a database creation unit 130, and an impersonation determination unit 140.

The storage unit 110 is a storage area allocated in a storage device such as the RAM 102 or the HDD 103 included in the control server 100. The storage unit 110 includes an image database 111 in which images captured during video communications are accumulated per person and a determination feature value database 112 in which data that the control server 100 refers to when performing the impersonation determination process is stored.

The processes performed by the video communication control unit 120, the database creation unit 130, and the impersonation determination unit 140 are each implemented by causing, for example, the processor 101 to execute a predetermined application program.

The video communication control unit 120 controls a video communication between communication terminals. In addition, the video communication control unit 120 stores moving image data transmitted from the communication terminals performing the video communication in the image database 111 in association with person IDs that identify the communicating people. In this way, moving image data indicating the past behaviors of the individual person is accumulated in the image database 111. In addition, when the impersonation determination unit 140 performs its determination process, the video communication control unit 120 enters the moving image data transmitted from the communication terminals performing the video communication to the impersonation determination unit 140 in addition to the person IDs indicating the communicating people.

The database creation unit 130 creates the determination feature value database 112 by analyzing the past behaviors of the individual person based on the moving image data accumulated in the image database 111. Feature values (determination feature values) indicating characteristic behaviors of an individual person (behaviors that are characteristic of an individual person) are registered in the determination feature value database 112 per person ID. Data indicating the locations and motions of a hand, a face, a head, etc., are registered as the feature values.

The impersonation determination unit 140 acquires the moving image data transmitted from the communication terminals performing the video communication from the video communication control unit 120. The impersonation determination unit 140 compares the behavior feature values of a communicating person included in an acquired moving image with the determination feature values that are registered in the determination feature value database 112 and that correspond to this communicating person, so as to determine whether the communicating person is actually the authentic person corresponding to the matching person ID. If the impersonation determination unit 140 determines that the communicating person is not the authentic person, the impersonation determination unit 140 determines that the communicating person included in the image is an impersonator or a composite image (a fake image) created to resemble the authentic person, for example.

The impersonation determination unit 140 may be included in any one of the communication terminals 200, 200a, 200b, etc. In this case, the determination feature value database 112 is stored in a storage device of the corresponding one of the communication terminals 200, 200a, 200b, etc., which includes the impersonation determination unit 140. In addition, the corresponding one of the communication terminals 200, 200a, 200b, etc. receives moving images captured by the other communication terminals, which are the video communication destinations, via the control server 100, enters the moving images to its impersonation determination unit 140, and determines whether the communicating people are the authentic people.

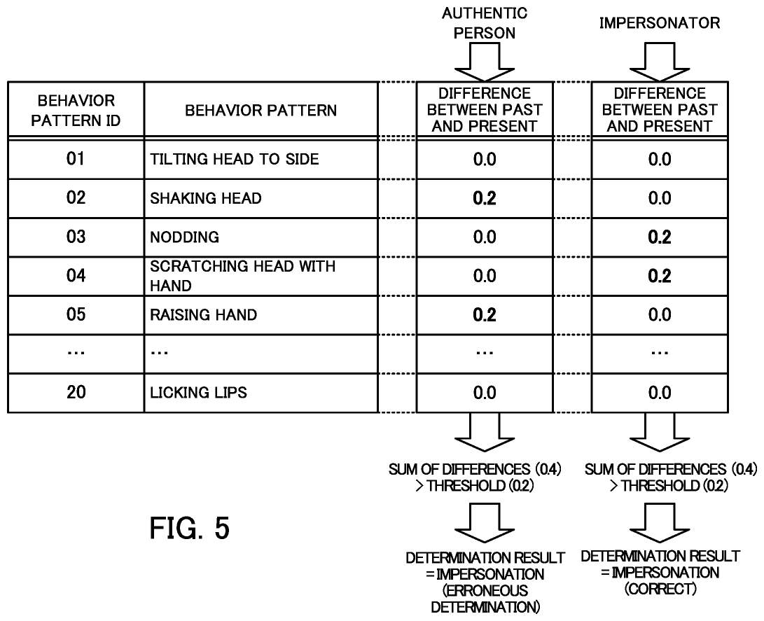

As described above, the following method as illustrated in FIG. 5 is conceivable as an impersonation determination method in which the feature values of past behaviors of a person are compared with the feature values of present behaviors of a person.

FIG. 5 illustrates a comparison example of an impersonation determination method. In this comparison example, behaviors are classified into a plurality of behavior patterns in advance. In addition, the control server 100 is configured to detect a behavior of a person included in an entered moving image and to determine whether the behavior matches any one of the behavior patterns. In the example in FIG. 5, the behaviors are classified into 20 patterns, and for identification, a behavior pattern ID is added to each behavior pattern.

From the moving images including a person that are accumulated in the image database 111, behavior feature values of this person are registered in the determination feature value database 112 per behavior pattern. That is, feature values of a person about all the behavior patterns are registered in the determination feature value database 112.

When performing the impersonation determination, the control server 100 acquires moving images of a person performing a video communication, detects behaviors from the moving images about the above behavior patterns, and calculates the feature values of the detected behaviors. Next, per behavior pattern, the control server 100 compares the feature values registered in the determination feature value database 112 with the feature values based on the acquired moving images and calculates a feature value difference. In FIG. 5, “difference between past and present” indicates a feature value difference calculated per behavior pattern as described above. If the calculated difference is equal to or greater than a predetermined threshold, the control server 100 determines impersonation.

In this comparison example, the feature values registered in the determination feature value database 112 per behavior pattern indicate behavior features of an individual person. However, people exhibit some of these behavior patterns in a similar way. Thus, the control server 100 could fail to detect impersonation or could erroneously determine the authentic person to be an impersonator.

In the example in FIG. 5, in a case where a person performing a video communication is an impersonator, a feature value difference “0.2” has been calculated for the behaviors corresponding to the behavior pattern IDs “03” and “04”. If the threshold is “0.2”, because a sum “0.4” of these differences is greater than the threshold, the control server 100 accurately determines impersonation. In contrast, in a case where the person performing the video communication is the authentic person, a feature value difference “0.2” has been calculated for the behaviors corresponding to the behavior patterns “02” and “05”. Because a sum “0.4” of these differences is greater than the threshold, the control server 100 erroneously determines impersonation, although the person performing the video communication is the authentic person.

To prevent this error determination, as the feature values of a person that are registered in the determination feature value database 112, it is better to use the feature values of “characteristic behaviors of this person”, which are behaviors characteristic of this person, instead of the feature values of this person about a plurality of previously determined behavior patterns.

Examples of the comparison between behaviors include two types of comparisons, that is, “comparison between past and present behaviors of a person” and “comparison between a behavior of a person and behaviors of other people”. In the former case, the behaviors to be compared may be classified into “past and present behaviors of a person that easily match” and “past and present behaviors of a person that do not easily match”. In the latter case, the behaviors to be compared may be classified into “a behavior of a person and behaviors of other people that easily match” or “a behavior of a person and behaviors of other people that do not easily match”.

In the above comparison example, in the comparison between past and present behaviors of a person, the control server 100 performs the comparison not only between past and present behaviors of the person that do not match easily but also between past and present behaviors of the person that easily match. It is conceivable that this operation could easily result in an erroneous determination. To improve the determination accuracy, the control server 100 needs to perform the comparison only between past and present behaviors of the person that do not match easily. In addition, in the case of the “comparison between a behavior of a person and behaviors of other people”, too, the control server 100 needs to perform the comparison only between a behavior of a person and behaviors of other people that do not easily match.

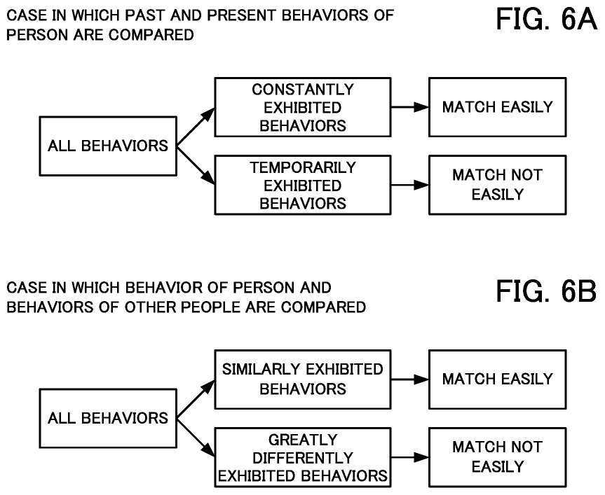

FIGS. 6A and 6B illustrate behaviors that are characteristic of a person. FIG. 6A illustrates a case in which past and present behaviors of a person are compared with each other, and FIG. 6B illustrates a case in which a behavior of a person and behaviors of other people are compared with each other.

Of all the behaviors exhibited by a person, some behaviors are unique to this person. These behaviors relate to reactions based on the limbic cortex of the person and are developed, for example, based on the growth environment of the person. These behaviors are constantly exhibited by the person. Thus, as illustrated in FIG. 6A, when past behaviors of a person are analyzed, the behaviors are classified into behaviors constantly exhibited by the person and behaviors temporarily exhibited by the person. The former behaviors easily match behaviors of a person acquired when the impersonation determination is performed, and it is fair to say that the former behaviors are “behaviors characteristic of the person”. However, the latter behaviors do not easily match behaviors of a person acquired when the impersonation determination is performed. Thus, it is desirable to perform the comparison only on the former behaviors when the impersonation determination is performed.

In contrast, regarding the comparison between a behavior of a person and behaviors of other people, as illustrated in FIG. 6B, the behaviors to be compared may be classified into behaviors that these people exhibit similarly and behaviors that these people exhibit greatly differently. The former behaviors easily match behaviors of other people acquired when the impersonation determination is performed, and the latter behaviors do not easily match behaviors of other people acquired when the impersonation determination is performed. Thus, it is fair to say that the latter behaviors are “characteristic behaviors”. For example, because most people exhibit a behavior of raising a hand in a similar way, this type of behaviors exhibited by people easily match when the impersonation determination is performed. In contrast, regarding a behavior of scratching the head, some people scratch their head with a palm of their hand whereas other people scratch their head with their finger. Thus, the behavior of scratching the head probably greatly differs from person to person, and this type of behaviors exhibited by people do not easily match when the impersonation determination is performed. Thus, it is desirable to perform the comparison only on the latter behaviors when the impersonation determination is performed.

Therefore, in embodiment 2-1 to be described below, the feature values of behaviors that greatly differ from those of other people are registered in the determination feature value database 112, and the comparison is made only on the feature values of these behaviors when the impersonation determination is performed. In addition, in embodiment 2-2, among the behaviors constantly exhibited by a person, the feature values of behaviors that greatly differ from those of other people are registered in the determination feature value database 112, and the comparison is made only on the feature values of these behaviors when the impersonation determination is performed.

### Embodiment 2-1

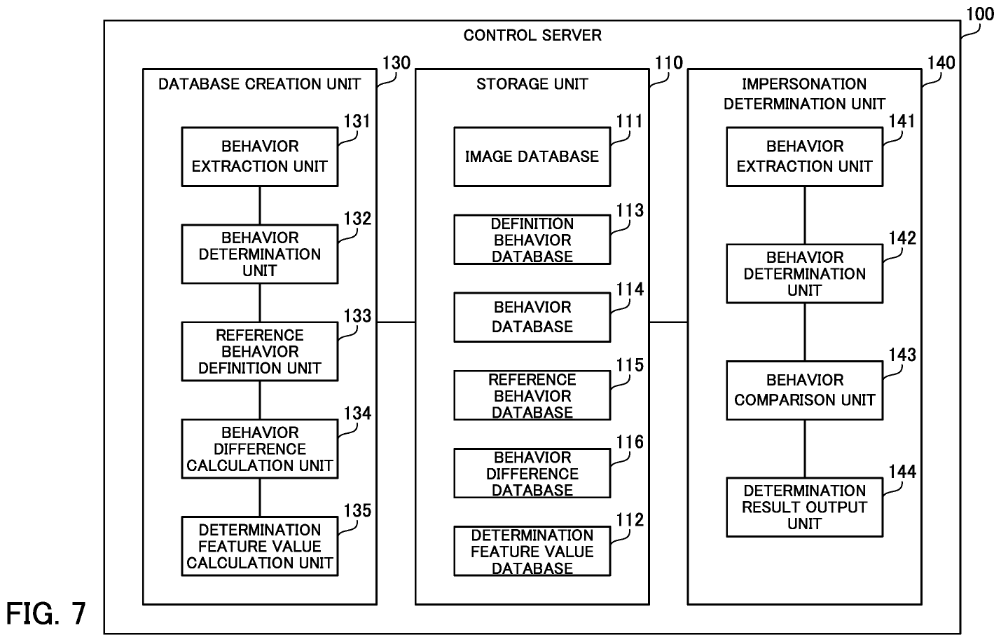

FIG. 7 illustrates an example of a configuration of a processing function of a control server according to embodiment 2-1. As illustrated in FIG. 7, the storage unit 110 of this control server 100 according to embodiment 2-1 stores a definition behavior database 113, a behavior database 114, a reference behavior database 115, and a behavior difference database 116, in addition to the above image database 111 and determination feature value database 112.

In the definition behavior database 113, feature values that define behaviors are registered (definition behavior feature values) per behavior pattern. The database creation unit 130 refers to the definition behavior database 113, so as to determine whether a behavior of a person included in an image matches any one of the behavior patterns in the definition behavior database 113.

In the behavior database 114, the feature values indicating the past behaviors exhibited by various people are registered per behavior pattern. These feature values are calculated based on the moving images stored in the image database 111.

In the reference behavior database 115, reference feature values among a plurality of people are registered per behavior pattern as reference behavior feature values. An individual reference behavior feature value indicates an average behavior of the past behaviors about a single behavior pattern exhibited by a plurality of people. An individual reference behavior feature value is used as a reference for calculating a determination feature value (a feature value indicating a characteristic behavior) of an individual person.

In the behavior difference database 116, a difference value between a feature value of a behavior exhibited by an individual person and a corresponding reference behavior feature value is registered. The behavior difference database 116 is temporarily created when the determination feature values of a person are calculated.

In addition, as illustrated in FIG. 7, the database creation unit 130 includes a behavior extraction unit 131, a behavior determination unit 132, a reference behavior definition unit 133, a behavior difference calculation unit 134, and a determination feature value calculation unit 135.

The behavior extraction unit 131 performs image recognition to extract feature values from the moving image data acquired from the image database 111 and calculates feature values that indicate motions of predetermined body parts of a person from the extracted feature values. The behavior extraction unit 131 continuously calculates the feature values over time from the moving images and stores the calculated feature values in a storage device (for example, the RAM 102) in association with the person ID of the person as a time-series feature value.

The behavior determination unit 132 compares the stored time-series feature value with the definition behavior feature values defined per behavior pattern in the definition behavior database 113, to determine whether the behaviors indicated by the time-series feature value match any one of the behavior patterns in the definition behavior database 113. If the behavior determination unit 132 determines a behavior indicated by any of the time-series feature value matches one of the behavior patterns, the behavior determination unit 132 generates a behavior feature value indicating the behavior of the matching behavior pattern based on the time-series feature value and registers the generated behavior feature value in the behavior database 114 in association with the matching person ID and behavior pattern ID. In this way, the feature values indicating the past behaviors exhibited by various people are classified into behavior patterns and registered in the behavior database 114.

The reference behavior definition unit 133 acquires the behavior feature values from the behavior database 114 per behavior pattern, calculates the feature values (the reference behavior feature values), each of which is used as a reference for a behavior pattern, based on the acquired behavior feature values, and registers the calculated feature values in the reference behavior database 115.

Based on the feature values registered in the behavior database 114, the behavior difference calculation unit 134 calculates, per person, the difference between a past behavior feature value and the corresponding reference behavior feature value. Specifically, the following process is performed per person. The behavior difference calculation unit 134 acquires the feature values from the behavior database 114 per behavior pattern, acquires the reference behavior feature values of the relevant behavior patterns from the reference behavior database 115, and calculates, per behavior pattern, the feature value difference value indicating the difference between these two kinds of feature values. The behavior difference calculation unit 134 registers the feature value difference values calculated per behavior pattern in the behavior difference database 116.

The determination feature value calculation unit 135 compares each of the feature value difference values registered in the behavior difference database 116 with a predetermined threshold. If the behavior difference value of a behavior pattern of a person is equal to or greater than the threshold, it is conceivable that the difference in this behavior pattern between the person and other people is large and that this behavior is characteristic of the person. Thus, the feature value of this behavior pattern is registered in the determination feature value database 112 as a determination feature value. In this way, the behavior feature values of the behavior patterns indicating the characteristic behaviors are registered in the determination feature value database 112 per person.

In addition, as illustrated in FIG. 7, the impersonation determination unit 140 includes a behavior extraction unit 141, a behavior determination unit 142, a behavior comparison unit 143, and a determination result output unit 144.

First, moving images are transmitted from the communication terminals performing a video communication. Next, the behavior extraction unit 141 acquires data of the transmitted moving images from the video communication control unit 120 and performs image recognition so as to extract a time-series feature value acquired from the moving image data.

The behavior determination unit 142 compares the extracted time-series feature value with the definition behavior feature values defined per behavior pattern in the definition behavior database 113, so as to determine whether the behavior indicated by the time-series feature value matches one of the behavior patterns in the definition behavior database 113. If the behavior determination unit 142 determines that the behavior indicated by the time-series feature value matches one of the behavior patterns, the behavior determination unit 142 generates a behavior feature value indicating the behavior of the matching behavior pattern based on the time-series feature value.

The processes performed by the behavior extraction unit 141 and the behavior determination unit 142 are continuously performed, for example, until a certain time elapses. The generated behavior feature values are stored in a storage device (the RAM 102, for example) in association with their respective behavior pattern IDs.

The behavior comparison unit 143 acquires the stored behavior feature values, acquires the determination feature values about the behavior patterns corresponding to the stored behavior feature values from the determination feature value database 112, and compares the difference between one of the stored feature values and the corresponding determination feature value with a predetermined threshold. If the difference is equal to or less than the threshold, the behavior comparison unit 143 determines that the behavior indicated by this behavior feature value (this behavior of the person performing the communication) matches the behavior indicated by the corresponding determination feature value (a characteristic behavior). Of all the behavior patterns, the behavior comparison unit 143 determines how many behaviors of the communicating person match characteristic behaviors. If the number of patterns determined is equal to or greater than a predetermined threshold, the behavior comparison unit 143 determines that the person performing the communication is the authentic person. However, if the number of patterns determined is less than the predetermined threshold, the behavior comparison unit 143 determines impersonation.

The determination result output unit 144 outputs an impersonation determination result. For example, the determination result output unit 144 displays the impersonation determination result on the display device of the communication terminal with which the determination target person is communicating.

Next, a process performed by the control server 100 according to embodiment 2-1 will be described with reference to a flowchart.

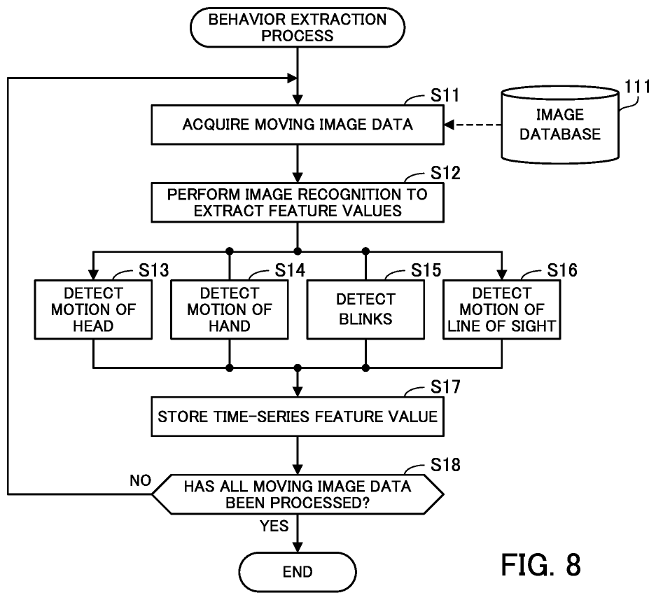

FIG. 8 is an example of a flowchart illustrating a procedure of a behavior extraction process performed by the behavior extraction unit.

[Step S11] The behavior extraction unit 131 acquires moving image data from the image database 111. The person ID of a person who is performing a communication during capturing of the moving image has been added to the acquired moving image data.

[Step S12] The behavior extraction unit 131 performs image recognition to extract feature values from the individual frames of the acquired moving image data. For example, coordinates of predetermined body parts are extracted as the feature values.

[Step S13] The behavior extraction unit 131 detects the motion of the head based on the extracted feature values.

[Step S14] The behavior extraction unit 131 detects the motion of each hand based on the extracted feature values.

[Step S15] The behavior extraction unit 131 detects blinks based on the extracted feature values.

[Step S16] The behavior extraction unit 131 detects the motion of the line of sight based on the extracted feature values.

The above steps S13 to S16 may be performed in parallel or in order. In the latter case, steps S13 to S16 may be performed in any order.

[Step S17] The behavior extraction unit 131 stores a time-series feature value based on the results of the detections in steps S13 to S16 in a storage device.

[Step S18] The behavior extraction unit 131 determines whether all the moving image data stored in the image database 111 has been processed. If there is unprocessed moving image data, the process returns to step S11, and the behavior extraction unit 131 acquires one of the unprocessed moving image data. In contrast, if all the moving image data has been processed, the behavior extraction unit 131 ends the behavior extraction process.

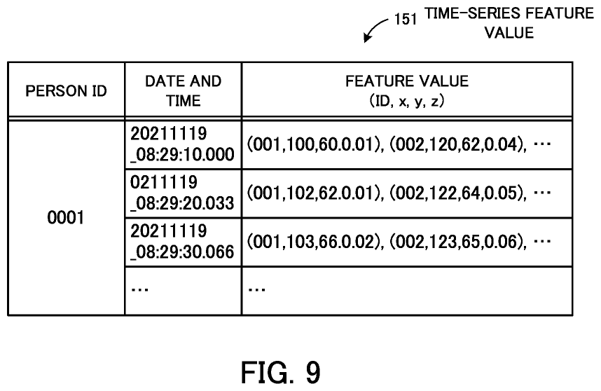

FIG. 9 illustrates a data structure example of a time-series feature value. For example, a time-series feature value 151 as illustrated in FIG. 9 is stored in step S17 in FIG. 8.

In the time-series feature value 151, “date and time” and “feature value” are registered in a plurality of sets in association with a person ID. The “date and time” indicates the date and time of the capturing of a frame. The “feature value” indicate the feature value extracted from a frame. As this feature value, for each of the body parts extracted from the corresponding frame, an ID identifying a body part and coordinates of the body part on the corresponding frame are registered.

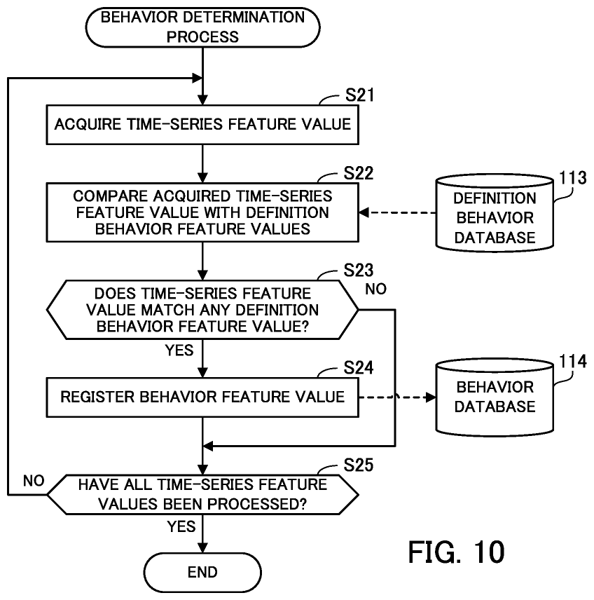

FIG. 10 is an example of a flowchart illustrating a procedure of a behavior determination process performed by the behavior determination unit.

[Step S21] The behavior determination unit 132 acquires one of the time-series feature values stored by the process in FIG. 8.

[Step S22] The behavior determination unit 132 compares the acquired time-series feature value with the definition behavior feature values registered per behavior pattern in the definition behavior database 113.

[Step S23] The behavior determination unit 132 determines whether the time-series feature value matches the definition behavior feature value of any one of the behavior patterns. If the time-series feature value matches the definition behavior feature value of any one of the behavior patterns, the process proceeds to step S24. If not, the process proceeds to step S25.

[Step S24] The behavior determination unit 132 calculates, based on the time-series feature value acquired in step S21, a behavior feature value about the matching behavior pattern. The behavior determination unit 132 associates the calculated behavior feature value with at least the corresponding person ID and behavior pattern ID and registers the associated data in the behavior database 114.

[Step S25] The behavior determination unit 132 determines whether all the time-series feature values stored in the process in FIG. 8 have been processed. If there is an unprocessed time-series feature value, the process proceeds to step S21, and the behavior determination unit 132 acquires one of the unprocessed time-series feature values. In contrast, if all the time-series feature values have been processed, the behavior determination unit 132 ends the behavior determination process.

Through the above process, the feature values indicating the past behaviors exhibited by various people are registered in the behavior database 114 per behavior pattern.

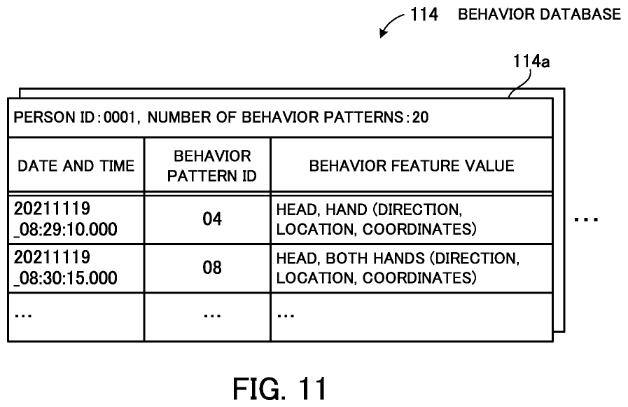

FIG. 11 illustrates a data structure example of the behavior database. As illustrated in FIG. 11, a table 114a is registered in the behavior database 114 per person.

In the table 114a, a person ID and the number of detected behavior patterns are associated with each other. In addition, a record including “date and time”, “behavior pattern ID”, and “behavior feature value” is registered in the table 114a. The “date and time” indicates the initial date and time, of all the dates and times added to a time-series feature value obtained by detecting a behavior about a behavior pattern (that is, the date and time at which the detection of a matching behavior is started). The “behavior pattern ID” indicates the behavior pattern of a detected behavior. The “behavior feature value” is the individual feature value calculated in step S24 in FIG. 10.

The kind of data registered as a behavior feature value is previously determined per behavior pattern ID. For example, if a behavior pattern ID “04” indicates the behavior “scratching head with hand”, the direction, the location, and the coordinates of the head and a hand are registered as the behavior feature value. If a behavior pattern ID “08” indicates the behavior “bringing both hands behind head”, the direction, location, and coordinates of the head, the right hand, and the left hand are registered as the behavior feature value. For example, the “coordinates” included in a behavior feature value indicates coordinates of at least one feature point on the corresponding body part, and the “location” indicates a median value of the coordinates of the at least one feature point.

In the behavior database 114, it is desirable that a plurality of behavior feature values be registered about a single behavior pattern. In other words, it is desirable that moving image data be accumulated in the image database 111 such that a plurality of behaviors are captured about a single behavior pattern for each person. The behavior feature value may be a time-series feature value corresponding to a plurality of frames.

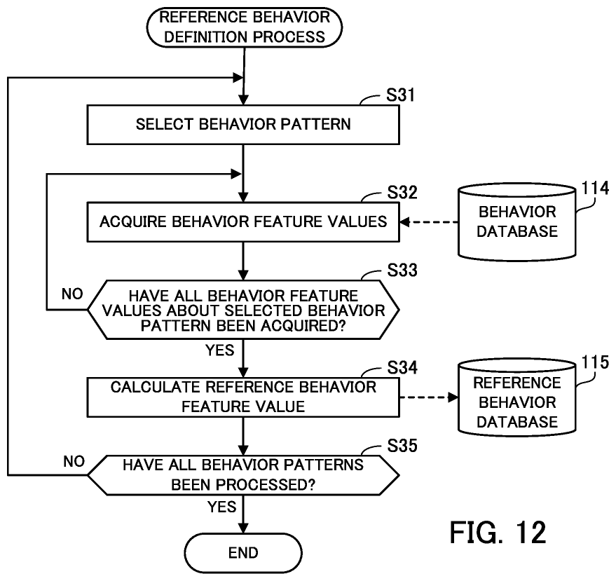

FIG. 12 is an example of a flowchart illustrating a procedure of a reference behavior definition process performed by the reference behavior definition unit.

[Step S31] The reference behavior definition unit 133 selects one behavior pattern from all the behavior patterns.

[Step S32] The reference behavior definition unit 133 acquires the behavior feature values about the selected behavior pattern from the behavior database 114. In this process, all the behavior feature values about the selected behavior pattern are acquired, regardless of person ID.

[Step S33] The reference behavior definition unit 133 determines whether all the behavior feature values about the selected behavior pattern have been acquired from the behavior database 114. If there are unacquired behavior feature values, the process returns to step S32, and the reference behavior definition unit 133 acquires one of the unacquired behavior feature values among the behavior feature values about the selected behavior pattern. If all the behavior feature values have been acquired, the process proceeds to step S34.

[Step S34] The reference behavior definition unit 133 calculates, based on the behavior feature values acquired in step S32, a reference behavior feature value about the selected behavior pattern. For example, the reference behavior definition unit 133 calculates the reference behavior feature value as a median value or an average value of the behavior feature values acquired in step S32 per parameter. When the behavior feature values are time-series feature values, for example, by expressing each time-series feature value as a vector and calculating an average of these vectors, it is possible to calculate a time-series reference behavior feature value. The reference behavior definition unit 133 associates the calculated reference behavior feature value with the corresponding behavior pattern ID and registers the associated data in the reference behavior database 115.

[Step S35] The reference behavior definition unit 133 determines whether all the behavior patterns have been processed. If there are unprocessed behavior patterns, the process returns to step S31, and the reference behavior definition unit 133 selects one of the unprocessed behavior patterns. If all the behavior patterns have been processed, the reference behavior definition unit 133 ends the reference behavior definition process.

By performing the above process, the reference behavior definition unit 133 calculates, per behavior pattern, a reference behavior feature value used as a reference for calculating the feature value of a behavior characteristic of a person in comparison to those of other people.

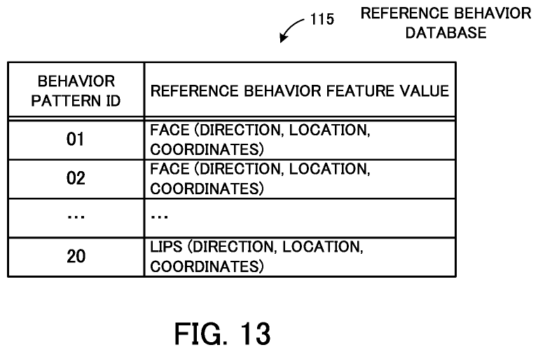

FIG. 13 illustrates a data structure example of the reference behavior database. As illustrated in FIG. 13, in the reference behavior database 115, a reference behavior feature value is registered per behavior pattern ID. The data format of the reference feature values is the same as that of the behavior feature values about their respective behavior pattern IDs. When the behavior feature values are time-series feature values, the reference behavior feature values are also time-series feature values.

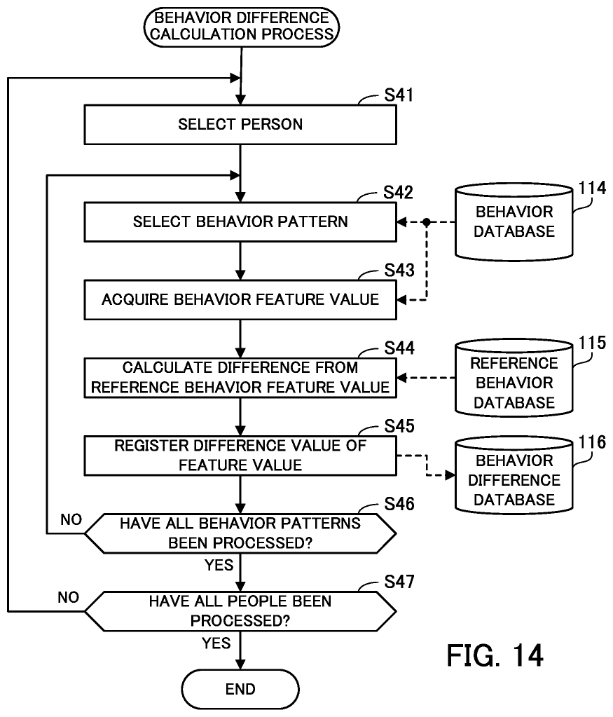

FIG. 14 is an example of a flowchart illustrating a procedure of a behavior difference calculation process performed by the behavior difference calculation unit.

[Step S41] The behavior difference calculation unit 134 selects a process target person.

[Step S42] The behavior difference calculation unit 134 refers to the behavior database 114 and selects one of the behavior patterns associated with the person ID of the selected person.

[Step S43] The behavior difference calculation unit 134 acquires, from the behavior database 114, a behavior feature value corresponding to the selected behavior pattern.

[Step S44] The behavior difference calculation unit 134 acquires, from the reference behavior database 115, a reference behavior feature value corresponding to the behavior pattern selected in step S42, and calculates the difference between this reference behavior feature value and the behavior feature value acquired in step S43 as the feature value difference value. If a plurality of behavior feature values are acquired in step S43, for example, a median value or an average value of the differences between the behavior feature values and the reference behavior feature value is calculated as the feature value difference value.

If the behavior feature values are time-series feature values, for example, the feature value difference value is calculated per parameter in the feature values as a vector difference (for example, an angular difference) or a Euclidean distance.

[Step S45] The behavior difference calculation unit 134 associates the calculated feature value difference value with the person ID indicating the person selected in step S41 and the behavior pattern ID indicating the behavior pattern selected in step S42 and registers the associated data in the behavior difference database 116.

[Step S46] The behavior difference calculation unit 134 determines whether all the behavior patterns have been processed. If there are unprocessed behavior patterns, the process returns to step S42, and the behavior difference calculation unit 134 selects one of the unprocessed behavior patterns. If all the behavior patterns have been processed, the process proceeds to step S47.

[Step S47] The behavior difference calculation unit 134 determines whether all the people have been processed. If there are unprocessed people, the process returns to step S41, and the behavior difference calculation unit 134 selects one of the unprocessed people. If all the people have been processed, the behavior difference calculation unit 134 ends the behavior difference calculation process.

By performing the above process, the behavior difference calculation unit 134 calculates, per person and per reference pattern, the feature value difference value indicating the difference between a past behavior of a person and behaviors of other people.

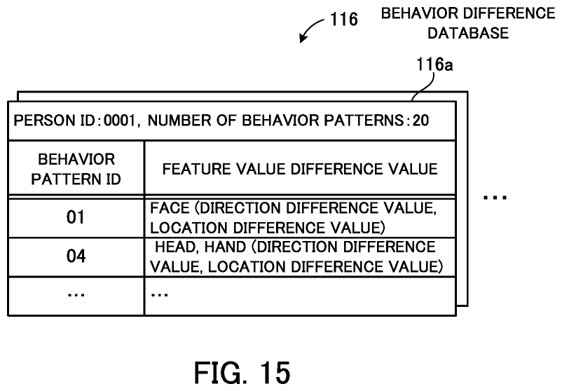

FIG. 15 illustrates a data structure example of the behavior difference database. As illustrated in FIG. 15, in the behavior difference database 116, a table 116a is registered per person. A person ID and the number of detected behavior patterns are associated with each other in the table 116a. In addition, a feature value difference value is registered in the table 116a per behavior pattern ID. As the feature value difference value, a difference value per parameter included in the corresponding behavior feature value is registered.

For example, a behavior pattern ID “01” indicates the behavior “tilting head to side”, and the direction, the location, and the coordinates of the face are registered as the behavior feature value corresponding to this behavior. In this case, a difference value about the direction of the face (a direction difference value) and a difference value about the location of the face (a location difference value) are registered as the feature value difference value. In addition, as described above, the behavior pattern ID “04” indicates the behavior “scratching head with hand”, and the direction, the location, and the coordinates of the head and a hand are registered as the behavior feature value corresponding to this behavior. In this case, the direction difference value and the location difference value about the head and the hand are registered as the feature value difference value.

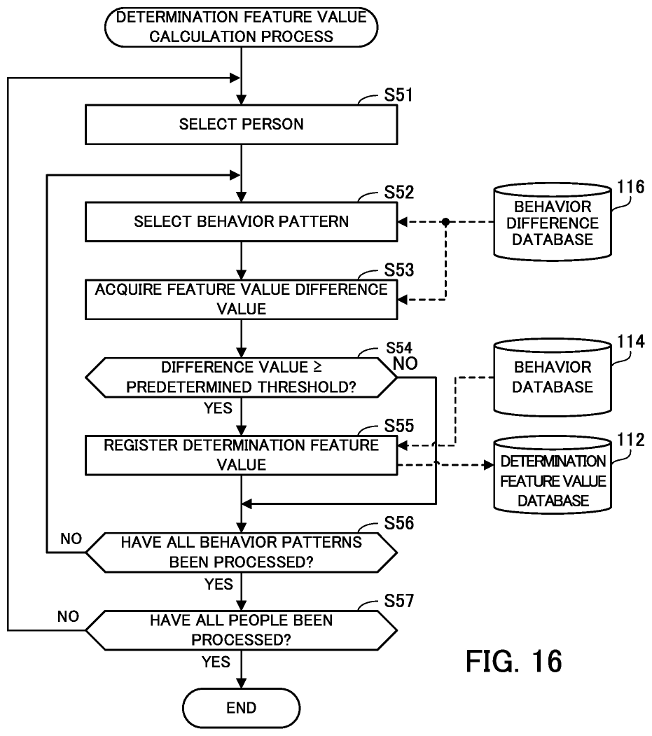

FIG. 16 is an example of a flowchart illustrating a procedure of a determination feature value calculation process performed by the determination feature value calculation unit.

[Step S51] The determination feature value calculation unit 135 selects a process target person.

[Step S52] The determination feature value calculation unit 135 refers to the behavior difference database 116 and selects one of the behavior patterns associated with the person ID of the selected person.

[Step S53] The determination feature value calculation unit 135 acquires a feature value difference value corresponding to the selected behavior pattern from the behavior difference database 116.

[Step S54] The determination feature value calculation unit 135 determines whether the acquired feature value difference value is equal to or greater than a predetermined threshold. If the feature value difference value is equal to or greater than the threshold, the process proceeds to step S55. If the feature value difference value is less than the threshold, the process proceeds to step S56.

[Step S55] The determination feature value calculation unit 135 acquires the behavior feature value associated with the person selected in step S51 and the behavior pattern selected in step S52 from the behavior database 114. The determination feature value calculation unit 135 associates the acquired behavior feature value with the person ID of the person and the behavior pattern ID of the behavior pattern and registers the associated data in the determination feature value database 112 as the determination feature value.

In practice, a threshold is set for each parameter in the feature value. For example, if the absolute values of the differences of all the parameters are equal to or greater than their respective thresholds, the process proceeds to step S55. In addition, when a plurality of matching behavior feature values are registered in the behavior database 114, for example, a median value or an average value of these behavior feature values is registered as the determination feature value. When the behavior feature values are time-series feature values, for example, by expressing each time-series feature value as a vector and calculating an average of these vectors, it is possible to calculate a time-series determination feature value.

[Step S56] The determination feature value calculation unit 135 determines whether all the behavior patterns have been processed. If there are unprocessed behavior patterns, the process returns to step S52, and the determination feature value calculation unit 135 selects one of the unprocessed behavior patterns. If all the behavior patterns have been processed, the process proceeds to step S57.

[Step S57] The determination feature value calculation unit 135 determines whether all the people have been processed. If there are unprocessed people, the process returns to step S51, and the determination feature value calculation unit 135 selects one of the unprocessed people. If all the people have been processed, the determination feature value calculation unit 135 ends the determination feature value calculation process.

By performing the above process, the determination feature value calculation unit 135 determines, per person, behaviors of behavior patterns that greatly differ from those of other people to be characteristic behaviors. The determination feature values about these behavior patterns are registered in the determination feature value database 112.

In the process in FIG. 16, the behavior feature values of all the behavior patterns about which the feature value difference values are equal to or greater than the threshold are registered as their respective determination feature values. However, alternatively, of all the behavior patterns about which the feature value difference values are equal to or greater than the threshold, only the behavior feature values of a predetermined number of behavior patterns may be registered as their respective determination feature values in descending order of the feature value difference values.

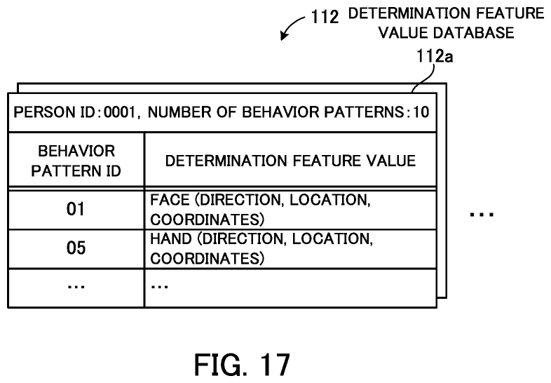

FIG. 17 illustrates a data structure example of the determination feature value database. As illustrated in FIG. 17, a table 112a is registered in the determination feature value database 112 per person. In the table 112a, a person ID and the number of behavior patterns indicating characteristic behaviors are associated with each other. In addition, in the table 112a, the determination feature value calculated in step S55 in FIG. 16 is registered for each of the behavior pattern IDs of the behavior patterns indicating the characteristic behaviors. The data format of the determination feature values is the same as that of the behavior feature values corresponding to their respective behavior pattern IDs. When the behavior feature values are time-series feature values, the determination feature values are also time-series feature values.

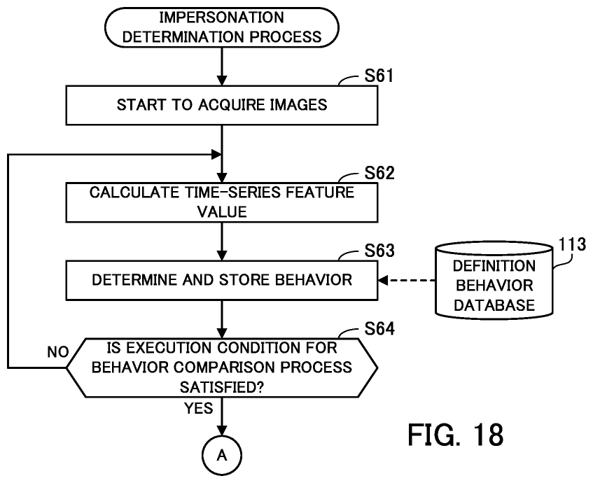

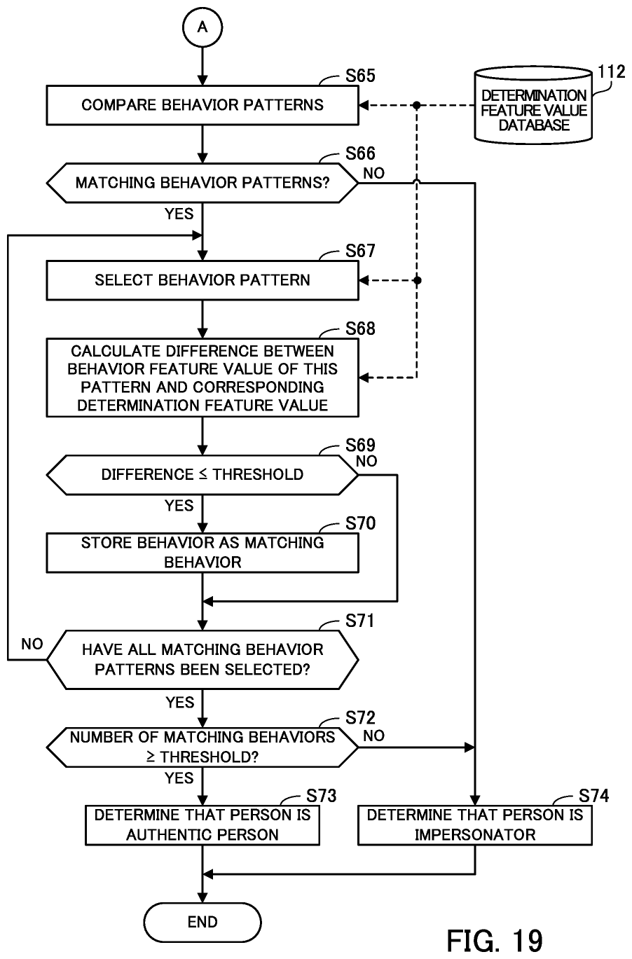

Next, an impersonation determination process using the determination feature value database 112 will be described. FIGS. 18 and 19 are each an example of a flowchart illustrating a procedure of an impersonation determination process performed by the impersonation determination unit.

[Step S61] The behavior extraction unit 141 of the impersonation determination unit 140 starts to acquire moving image data from the video communication control unit 120. The moving image data is moving image data that has been captured by a communication terminal performing a communication and that has been transmitted to the control server 100. In addition, in the moving image data, a person ID indicating an authentic person performing the communication is added, and this person ID is the number for identifying a determination target person.

[Step S62] In the same procedure as steps S12 to S17 in FIG. 8, the behavior extraction unit 141 performs image recognition to extract feature values from the frames of the moving image data, calculates time-series feature values based on the feature values, and stores the time-series feature values in a storage device (the RAM 102, for example).

[Step S63] The behavior determination unit 142 of the impersonation determination unit 140 compares the stored time-series feature values with the definition behavior feature values in the definition behavior database 113, so as to detect a behavior that matches any one of the behavior patterns, in the same procedure in FIG. 10. If a time-series feature value matches the definition behavior feature value of a behavior pattern, the behavior determination unit 142 calculates a behavior feature value corresponding to this behavior pattern based on the time-series feature value and stores the behavior feature value in a storage device in association with the corresponding behavior pattern ID.

[Step S64] The impersonation determination unit 140 determines whether an execution condition for a behavior comparison process is satisfied. The impersonation determination unit 140 determines that the execution condition is satisfied, for example, if a certain time has elapsed from the start of the process in FIG. 18 or if a certain number of behavior feature values have been stored in step S63. If the execution condition is not satisfied, the process returns to step S62, and steps S62 and S63 are continuously performed by using the acquired moving image data. If the execution condition is satisfied, the process proceeds to step S65, and the behavior comparison process is started.

[Step S65] The behavior comparison unit 143 of the impersonation determination unit 140 acquires, from the determination feature value database 112, all the behavior pattern IDs associated with the person ID of the determination target person (that is, the behavior pattern IDs of the behavior patterns indicating the characteristic behaviors). The behavior comparison unit 143 compares the acquired behavior pattern IDs with the behavior pattern IDs stored in step S63 (that is, the behavior pattern IDs of the behaviors detected from the determination target person).

[Step S66] The behavior comparison unit 143 determines whether at least one of the behavior pattern IDs acquired from the determination feature value database 112 in step S65 is included in the behavior pattern IDs stored in step S63. If at least one of the former behavior pattern IDs is included in the latter behavior patterns, the process proceeds to step S67. If none of the former behavior pattern IDs are included in the latter behavior pattern IDs, the process proceeds to step S74. For example, the process proceeds to step S74 if none of the characteristic behaviors are detected although behaviors of the determination target person have been detected or if the determination target person does not exhibit any behaviors (for example, if the determination target person stays still).

[Step S67] The behavior comparison unit 143 selects one of the behavior patterns included in the behavior pattern IDs stored in step S63 and in the behavior pattern IDs acquired from the determination feature value database 112 in step S65.

[Step S68] The behavior comparison unit 143 acquires, from the behavior feature values stored in step S63, a behavior feature value corresponding to the behavior pattern ID selected in step S67. In addition, the behavior comparison unit 143 acquires a determination feature value corresponding to the behavior pattern ID selected in step S67 from the determination feature value database 112. Next, the behavior comparison unit 143 calculates the difference between these feature values. When a plurality of behavior feature values corresponding to the behavior pattern ID have been stored in step S63, for example, a median value or an average value of these behavior feature values is calculated, and the difference between this calculation result and the corresponding determination feature value is calculated.

If the behavior feature values are time-series feature values, for example, the feature value difference value is calculated per parameter in the feature values as a vector difference (for example, an angular difference) or a Euclidean distance.

[Step S69] The behavior comparison unit 143 determines whether the absolute value of the calculated difference is equal or less than a predetermined threshold. If the absolute value of the difference is equal or less than the threshold, the process proceeds to step S70. If the absolute value of the difference exceeds the threshold, the process proceeds to step S71. In practice, a threshold is set for each parameter in the feature value. For example, if the absolute values of the differences of all the parameters are equal to or less than their respective thresholds, the process proceeds to step S70.

[Step S70] The behavior comparison unit 143 stores the behavior pattern ID selected in step S67 in a storage device as the behavior pattern ID of a behavior matching the characteristic behavior.

[Step S71] The behavior comparison unit 143 determines whether all the matching behavior pattern IDs have been selected in step S67. If there are unselected behavior pattern IDs, the process returns to step S67, and the behavior comparison unit 143 selects one of the unselected behavior pattern IDs. If all the matching behavior patterns have been selected, the process proceeds to step S72.

[Step S72] The behavior comparison unit 143 determines whether the number of behavior pattern IDs stored in step S70, that is, the number of behaviors that match characteristic behaviors, is equal to or greater than a predetermined threshold. If the number of behaviors is equal to or greater than the threshold, the process proceeds to step S73. If the number of behaviors is less than the threshold, the process proceeds to step S74. A different threshold may be used per behavior pattern.

[Step S73] The behavior comparison unit 143 determines that the determination target person is the authentic person. The determination result output unit 144 outputs information indicating this determination result.

[Step S74] The behavior comparison unit 143 determines that the determination target person is an impersonator. The determination result output unit 144 outputs information indicating this determination result.

In steps S73 and S74, for example, the determination result output unit 144 displays the determination result on the display device of the communication terminal with which the determination target person is communicating. In addition, in step S74, information indicating impersonation is displayed as the determination result, for example.

In the above process, if a plurality of behavior patterns of behaviors are detected from the moving images captured during the communication, the comparison with the determination feature values is performed only on the behaviors that greatly differ from those of other people, of all the behaviors. If at least a predetermined number of detected behaviors are determined to be behaviors that greatly differ from those of other people (that is, if at least a predetermined number of detected behaviors are determined to be characteristic behaviors), the behavior comparison unit 143 determines that the determination target person is the authentic person. In this way, it is possible to achieve a better accuracy in determining whether the determination target person is the authentic person (or an impersonator) than the accuracy in the comparison example illustrated in FIG. 5.

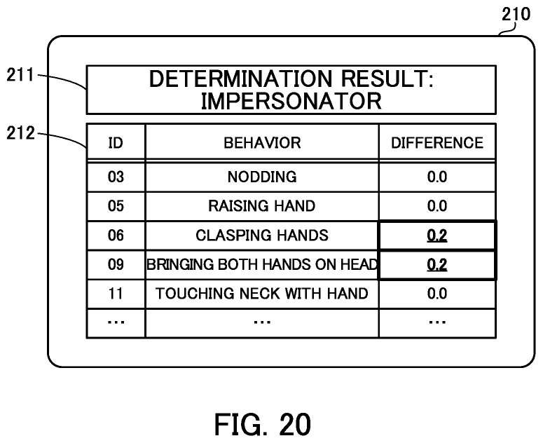

FIG. 20 illustrates an example of a determination result display screen. This display screen 210 illustrated in FIG. 20 is an example of a screen displayed on the display device of the communication destination terminal in steps S73 and S74.

This display screen 210 displays a determination result display area 211 indicating the impersonation determination result. FIG. 20 illustrates an example in which step S74 has been performed, and the determination of the impersonation is displayed in the determination result display area 211.

In addition, the display screen 210 also displays a behavior detection result display area 212 indicating a behavior detection result. The behavior detection result display area 212 displays a record for each characteristic behavior exhibited by the target person. Each record includes an ID (a behavior pattern ID) identifying a behavior pattern, explanatory text of the behavior, and the difference. As this difference, the absolute value of the difference between feature values calculated in step S68 in FIG. 19 is displayed.

In the above example, the information indicating whether the determination target person is the authentic person (or an impersonator) is displayed as the information indicating the determination. However, for example, as the information indicating the result, a numerical value indicating the probability that the determination target person is the authentic person or the probability that the determination target person is an impersonator may alternatively be displayed based on a sum of the absolute values of the differences calculated in step S68.

### Embodiment 2-2

Embodiment 2-2 is a variation obtained by modifying part of the process performed by the control server 100 according to the above embodiment 2-1. According to embodiment 2-1, behavior feature values that greatly differ from those of other people are registered in the determination feature value database 112. In contrast, according to embodiment 2-2, first, behaviors constantly exhibited by a person are determined based on past behaviors of the person. Next, of all the behaviors constantly exhibited by this person, the feature values of behaviors that greatly differ from those of other people are registered in the determination feature value database 112.

As illustrated in FIG. 6A, behaviors constantly exhibited by a person easily match behaviors of the person acquired when impersonation determination is performed. However, these behaviors may easily match behaviors of other people. In contrast, as illustrated in FIG. 6B, behaviors that greatly differ from those of other people do not easily match those of other people when the impersonation determination is performed. Thus, first, behaviors that greatly differ from those of other people are selected from all the behaviors constantly exhibited by a person, and next, the feature values of these behaviors are registered in the determination feature value database 112. In this way, it is possible to use the feature values of behaviors that easily match behaviors of the authentic person and that do not easily match behaviors of other people when the impersonation determination is performed. As a result, the accuracy in determining whether the determination target person is the authentic person is improved.

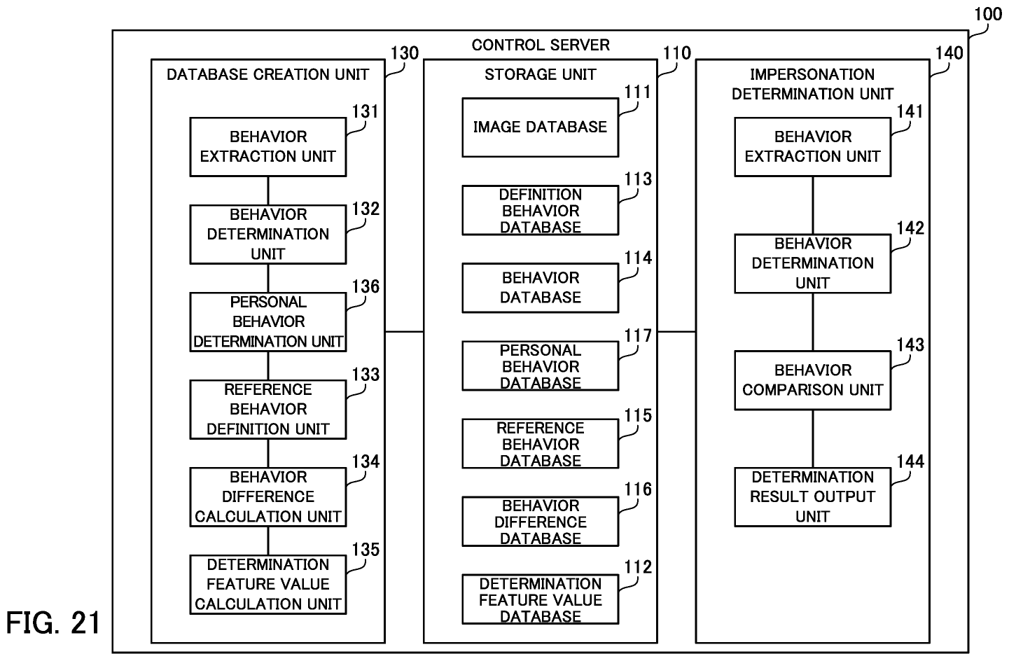

FIG. 21 illustrates an example of a configuration of a processing function of the control server according to embodiment 2-2. As illustrated in FIG. 21, a personal behavior database 117 is further stored in the storage unit 110 of the control server 100 according to embodiment 2-2. In addition, the database creation unit 130 further includes a personal behavior determination unit 136.

The personal behavior determination unit 136 calculates, per person, the behavior feature value variation range registered per behavior pattern in the behavior database 114 (the difference between the maximum value and the minimum value) and determines whether the calculated variation range is equal to or less than an allowable value set per behavior pattern. If the variation range about a behavior pattern is equal to or less than its corresponding allowable value, the personal behavior determination unit 136 determines that the behavior corresponding to this behavior pattern is a behavior constantly exhibited by this person, associates the behavior feature values corresponding to this behavior pattern (personal behavior feature values) with the corresponding behavior pattern ID, and registers the associated data in the personal behavior database 117. Thus, the behavior pattern IDs of behaviors constantly exhibited by people and the personal behavior feature values indicated by these behaviors are at least associated with each other and registered in the personal behavior database 117 per person.

The reference behavior definition unit 133 acquires the behavior feature values from the personal behavior database 117, not from the behavior database 114, calculates a reference behavior feature value per behavior pattern, and registers the calculated reference behavior feature values in the reference behavior database 115. In addition, the behavior difference calculation unit 134 compares the behavior feature values acquired from the personal behavior database 117, not from the behavior database 114, with their respective reference behavior feature values, and registers the feature value difference values in the behavior difference database 116 per behavior pattern.

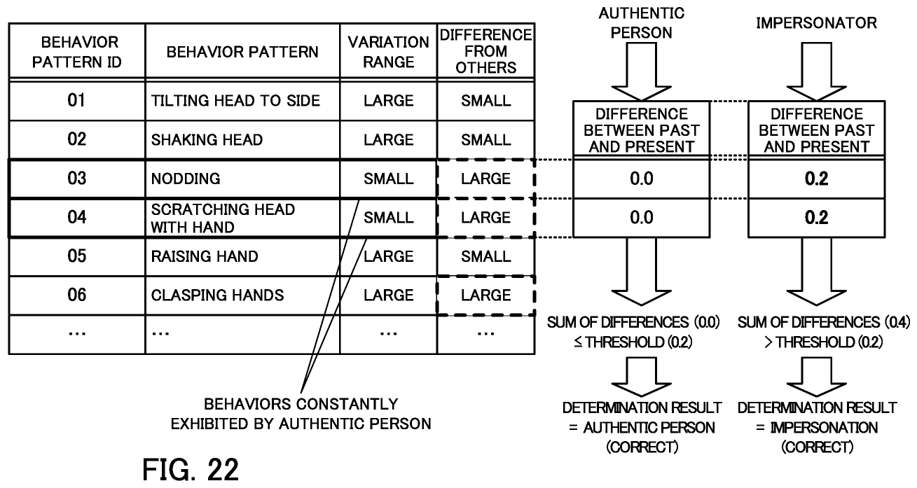

FIG. 22 illustrates an impersonation determination method according to embodiment 2-2. In FIG. 22, the behaviors are classified to 20 behavior patterns.

As described above, the personal behavior determination unit 136 calculates, about a person, the behavior feature value variation range per behavior pattern from the behavior database 114 and determines whether each variation range is equal to or less than its corresponding allowable value. In FIG. 22, if a variation range is equal to or less than its corresponding allowable value, the variation range is indicated by “small”. If the variation range exceeds the allowable value, the variation range is indicated by “large”. In the example in FIG. 22, the variation ranges corresponding to the behavior pattern IDs “03” and “04” are indicated by “small”, and the corresponding behaviors are determined to be behaviors constantly exhibited by the authentic person.

In addition, in the example in FIG. 22, the behaviors of the behavior patterns “03”, “04”, and “06” greatly differ from those of other people. The determination feature value calculation unit 135 registers, of all these behavior patterns, the determination feature values indicating the behaviors of the behavior patterns “03” and “04” whose variation range has been determined to be “small” in the determination feature value database 112.

In this case, of all the behaviors detected from the moving images captured by the communication terminal, the impersonation determination unit 140 compares only the feature values of the behaviors of the behavior patterns “03” and “04” with their respective determination feature values. For example, assuming that a moving image including the authentic person has been entered and that “0.0” has been calculated as the difference between the feature values for each of the behaviors corresponding to the behavior patterns ID “03” and “04”, a sum “0.0” of the differences is less than a threshold “0.2”. Thus, the impersonation determination unit 140 accurately determines that the determination target person is the authentic person. In contrast, assuming that a moving image including an impersonator has been entered and that “0.2” has been calculated as the difference between the feature values for each of the behaviors corresponding to the behavior pattern IDs “03” and “04”, a sum “0.4” of the differences is greater than the threshold “0.2”. Thus, the impersonation determination unit 140 accurately determines that the determination target person is not the authentic person (that the determination target person is an impersonator).

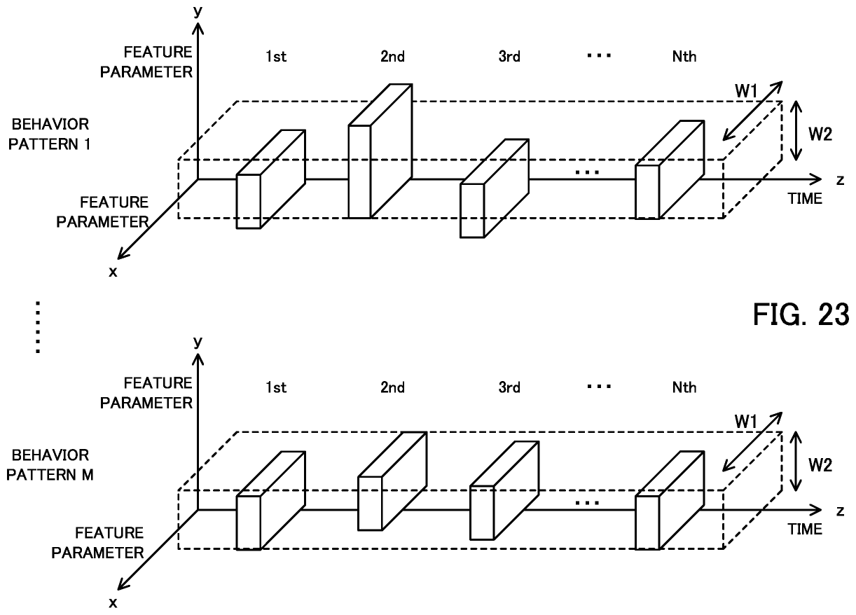

FIG. 23 conceptually illustrates a process for determining behaviors constantly exhibited by a person. FIG. 23 assumes that there are two kinds of behavior feature value parameters (feature parameters). The values of one kind are plotted on the x axis, and the values of the other kind are plotted on the y axis. FIG. 23 also assumes that there are M behavior patterns and that, regarding a person, a number N of behaviors have been detected per behavior pattern from the moving image data in the image database 111. FIG. 23 also assumes that an allowable value W1 is set for the parameters on the x axis and that an allowable value W2 is set for the parameters on the y axis.

In the example in FIG. 23, whereas the variation range of the behavior pattern 1 exceeds its corresponding allowable values, the variation range of the behavior pattern M falls within its corresponding allowable values. In this case, whereas the behavior feature values of the behavior pattern 1 are not registered in the personal behavior database 117 as personal behavior feature values, the behavior feature values of the behavior pattern M are registered in the personal behavior database 117 as personal behavior feature values. That is, the behaviors of the behavior pattern M are determined to be behaviors constantly exhibited by this person.

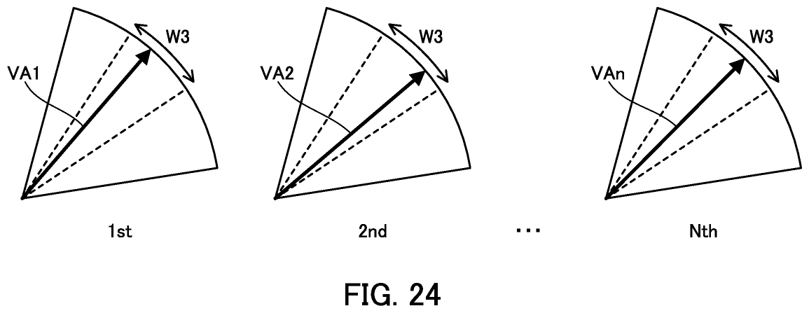

FIG. 24 illustrates a calculation example of a behavior variation range. FIG. 24 illustrates an example in which behavior feature values of a certain person about a certain behavior pattern are expressed by vectors. The behavior feature value of a behavior detected at the first time is expressed by a vector VA1, the behavior feature value of a behavior detected at the second time is expressed by a vector VA2, and the behavior feature value of a behavior detected at the Nth time is expressed by a vector VAn.

In this case, a variation range W3 of the behavior feature values are expressed by the difference between the minimum angle and the maximum angle among the vectors VA1, VA2, . . . , and VAn, For example. If the variation range W3 is equal to or less than its corresponding allowable value, a behavior of this behavior pattern is determined to be a behavior constantly exhibited by this person.

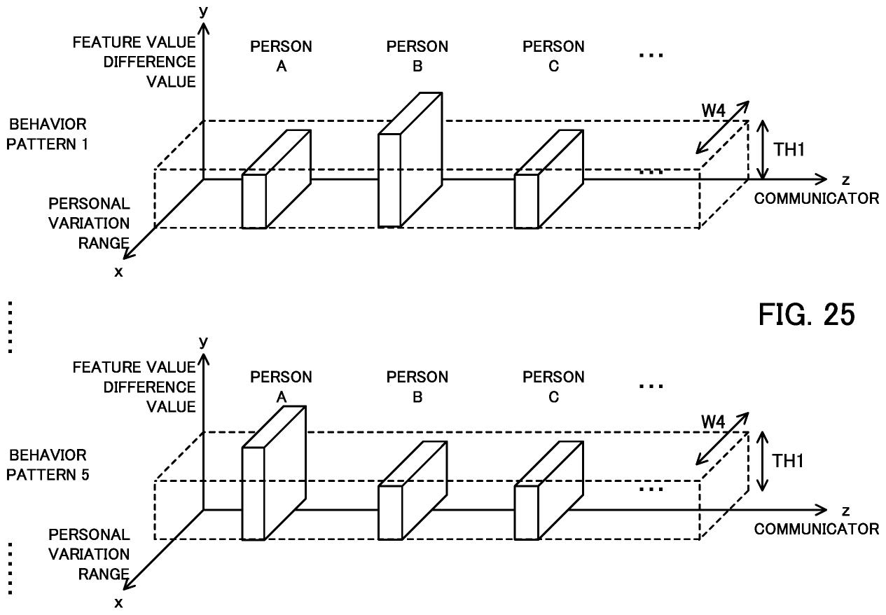

FIG. 25 conceptually illustrates a determination feature value selection process. In FIG. 25, behavior feature value variation ranges about a single person (personal variation ranges) are plotted on the x axis, and feature value difference values (difference values between behavior feature values and their respective reference behavior feature values) about an individual person are plotted on the y axis. An allowable value W4 is an allowable value of the behavior feature value variation ranges about a single person. A threshold TH1 is a determination threshold for comparison with the feature value difference values.

In the example in FIG. 25, about the behavior pattern 1, the behavior feature value variation ranges of a person A to a person C fall within the allowable value W4. However, among these people A to C, the feature value difference value of only the person B exceeds the threshold TH1. Thus, the behavior feature value of the behavior pattern 1 exhibited by the person B is registered in the determination feature value database 112 as a determination feature value. In addition, about the behavior pattern 5, the behavior feature value variation ranges of all the people A to C fall within the allowable value W4. However, among these people A to C, the feature value difference value of only the person A exceeds the threshold TH1. Thus, the behavior feature value of the behavior pattern 5 exhibited by the person A is registered in the determination feature value database 112 as a determination feature value.

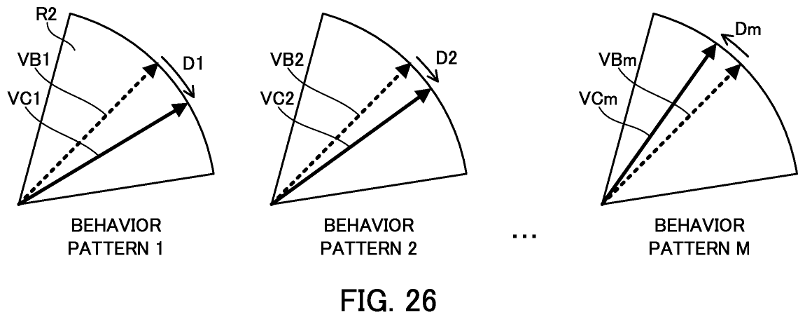

FIG. 26 illustrates a calculation example of a feature value difference value. FIG. 26 illustrates an example in which behavior feature values and reference behavior feature values of an individual person are expressed by vectors. Vectors VB1, VB2, . . . , and VBm are vectors that indicate the reference behavior feature values of the behavior patterns 1, 2, . . . , and M, respectively. Vectors VC1, VC2, . . . , and VCm are vectors that indicate the behavior feature values of the behavior patterns 1, 2, . . . , and M of an individual person, respectively.

The difference between a behavior feature value and a corresponding reference behavior feature value, that is, a feature value difference value, is expressed as the angular difference between corresponding vectors, for example. In the example in FIG. 26, the feature value difference values of the behavior patterns 1, 2, . . . , and M are angles D1, D2, . . . , and Dm.

Next, of all the processes according to embodiment 2-2, the processes different from those according to embodiment 2-1 will be described with reference to a flowchart.

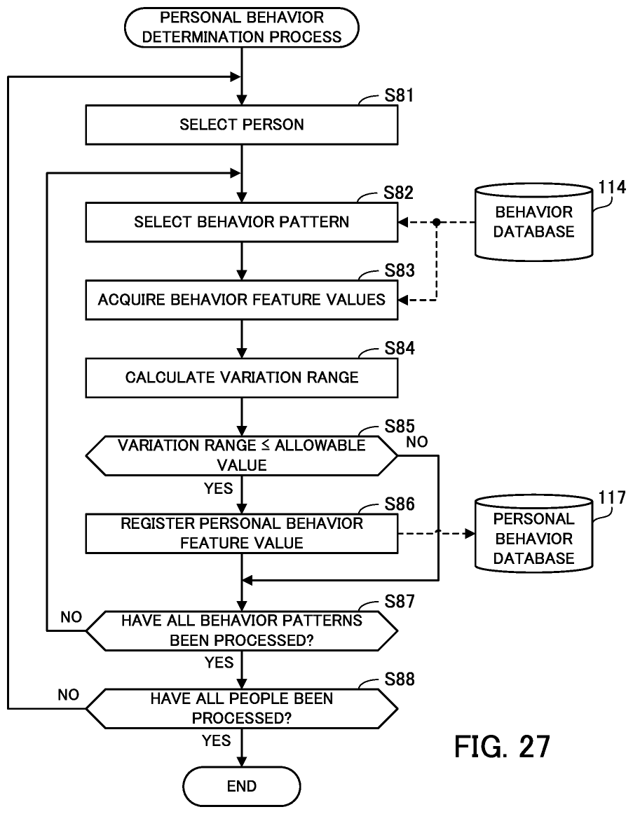

FIG. 27 is an example of a flowchart illustrating a procedure of a personal behavior determination process performed by the personal behavior determination unit.

[Step S81] The personal behavior determination unit 136 selects a process target person.

[Step S82] The personal behavior determination unit 136 refers to the behavior database 114 and selects one of the behavior patterns that is associated with the person ID of the selected person.

[Step S83] The personal behavior determination unit 136 acquires all the behavior feature values corresponding to the selected behavior pattern from the behavior database 114.

[Step S84] The personal behavior determination unit 136 calculates the variation range of the behavior feature values acquired in step S83.

[Step S85] The personal behavior determination unit 136 determines whether the calculated variation range is equal to or less than a predetermined allowable value. If the variation range is equal to or less than the predetermined allowable value, the process proceeds to step S86. If the variation range exceeds the allowable value, the process proceeds to step S87.

[Step S86] The personal behavior determination unit 136 calculates a median value or an average value of the behavior feature values acquired in step S83, associates the calculated value with the person ID of the person selected in step S81 and the behavior pattern ID of behavior pattern selected in step S82, and registers the associated data in the personal behavior database 117 as a personal behavior feature value.

[Step S87] The personal behavior determination unit 136 determines whether all the behavior patterns have been processed. If there are unprocessed behavior patterns, the process returns to step S82, and the personal behavior determination unit 136 selects one of the unprocessed behavior patterns. If all the behavior patterns have been processed, the process proceeds to step S88.

[Step S88] The personal behavior determination unit 136 determines whether all the people have been processed. If there are unprocessed people, the process returns to step S81, and the personal behavior determination unit 136 selects one of the unprocessed people. If all the people have been processed, the personal behavior determination unit 136 ends the personal behavior determination process.

By performing the above process, the personal behavior determination unit 136 registers, per person, the behavior feature values about the behavior patterns of behaviors constantly exhibited by people in the personal behavior database 117 as their personal behavior feature values.

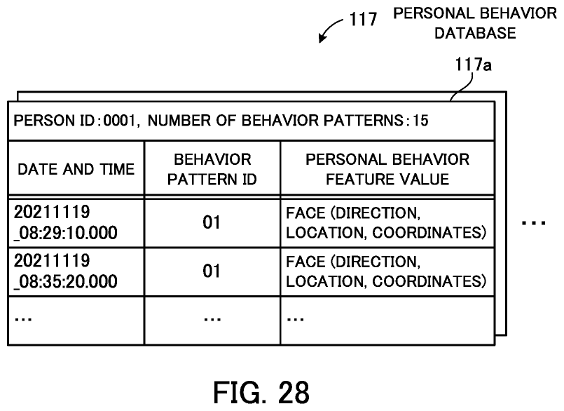

FIG. 28 illustrates a data structure example of the personal behavior database. As illustrated in FIG. 28, a table 117a is registered per person in the personal behavior database 117. In the table 117a, the person ID of a person and the number of behavior patterns of behaviors constantly exhibited by this person are associated with each other. In addition, a record including “date and time”, “behavior pattern ID”, and “personal behavior feature value” is registered in the table 117a. The content of the corresponding record in the behavior database 114 is registered without change in this record.

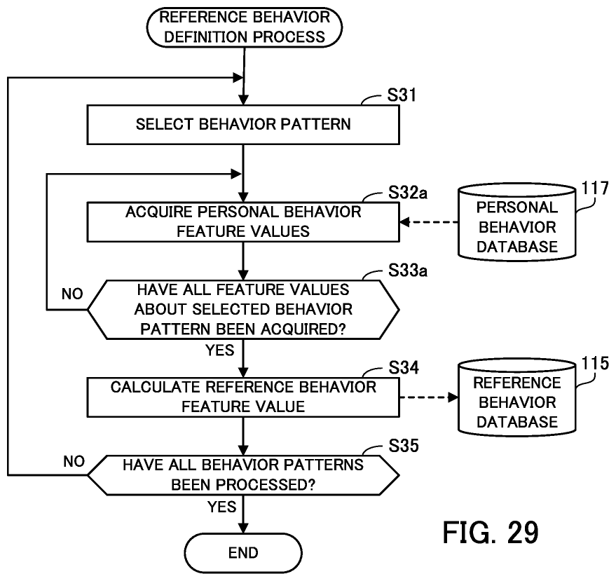

FIG. 29 is an example of a flowchart illustrating a procedure of a reference behavior definition process according to embodiment 2-2. In FIG. 29, the same steps as those in FIG. 12 are denoted by the step numbers. In the reference behavior definition process in FIG. 29, steps S32a and S33a are performed in place of steps S32 and S33 in FIG. 12, respectively.

[Step S32a] The reference behavior definition unit 133 acquires the personal behavior feature values about the selected behavior pattern from the personal behavior database 117. In this step, regardless of person ID, the reference behavior definition unit 133 acquires all the personal behavior feature values about the selected behavior pattern.

[Step S33a] The reference behavior definition unit 133 determines whether all the personal behavior feature values about the selected behavior pattern have been acquired from the personal behavior database 117. If there are unacquired personal behavior feature values, the process returns to step S32a, and the reference behavior definition unit 133 acquires one of the unacquired personal behavior feature values among the personal behavior feature values about the selected behavior pattern. If all the personal behavior feature values have been acquired, the process proceeds to step S34.

In step S34, the reference behavior definition unit 133 calculates a reference behavior feature value based on the personal behavior feature values acquired from the personal behavior database 117 in step S32a.

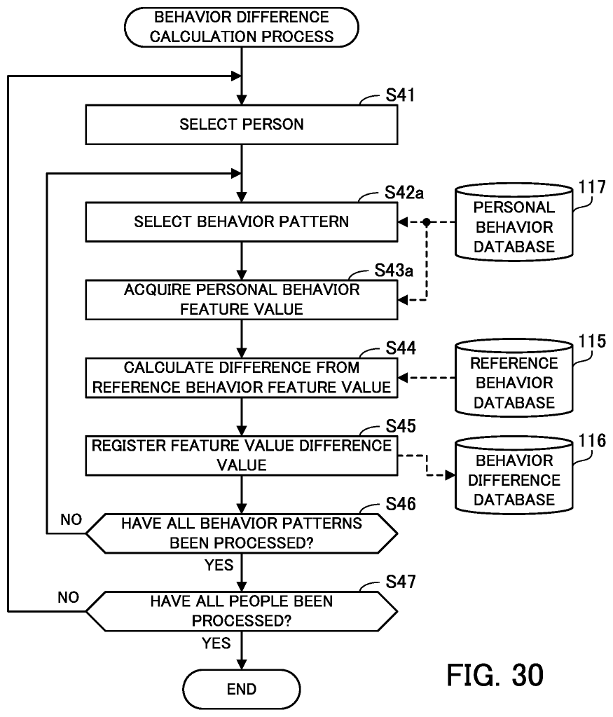

FIG. 30 is an example of a flowchart illustrating a procedure of a behavior difference calculation process according to embodiment 2-2. In FIG. 30, the same steps as those in FIG. 14 are denoted by the step numbers. In the behavior difference calculation process in FIG. 30, steps S42a and S43a are performed in place of steps S42 and S43 in FIG. 14, respectively.

[Step S42a] The behavior difference calculation unit 134 refers to the personal behavior database 117 and selects one of the behavior patterns associated with the person ID of the person selected in step S41.

[Step S43a] The behavior difference calculation unit 134 acquires a personal behavior feature value corresponding to the behavior pattern selected in step S42a from the personal behavior database 117.

In step S44, the behavior difference calculation unit 134 calculates the difference between the personal behavior feature value acquired from the personal behavior database 117 in step S43a and the corresponding reference behavior feature value as a feature value difference value.

Although the processing procedure of the determination feature value calculation unit 135 is the same as that in FIG. 16, the number of behavior patterns selected in step S52 could be less than that according to embodiment 2-1. As a result, the determination feature values registered in the determination feature value database 112 could differ from those registered according to embodiment 2-1. That is, according to embodiment 2-2, of all the determination feature values registered according to embodiment 2-1, only the determination feature values of the behaviors constantly exhibited by the corresponding person are registered in the determination feature value database 112.

In addition, in the process performed by the determination feature value calculation unit 135, in step S55 in FIG. 16, the behavior feature value may be acquired from the personal behavior database 117, not from the behavior database 114. In this way, a fewer number of records in the database are searched for the matching feature value, and the processing time is shortened.

By performing the process in FIG. 30, the behavior difference calculation unit 134 calculates and registers the feature value difference values only about the behavior patterns corresponding to the behaviors constantly exhibited by the person in the behavior difference database 116. Thus, of all the behaviors constantly exhibited by the person, the behavior patterns corresponding to the behaviors that greatly differ from those of other people are determined based on a threshold, and the behavior feature values of the determined behavior patterns are registered in the determination feature value database 112 as the determination feature values.

### Embodiment 2-3

Embodiment 2-3 is a variation obtained by modifying part of the process performed by the control server 100 according to embodiment 2-1 or embodiment 2-2 described above.

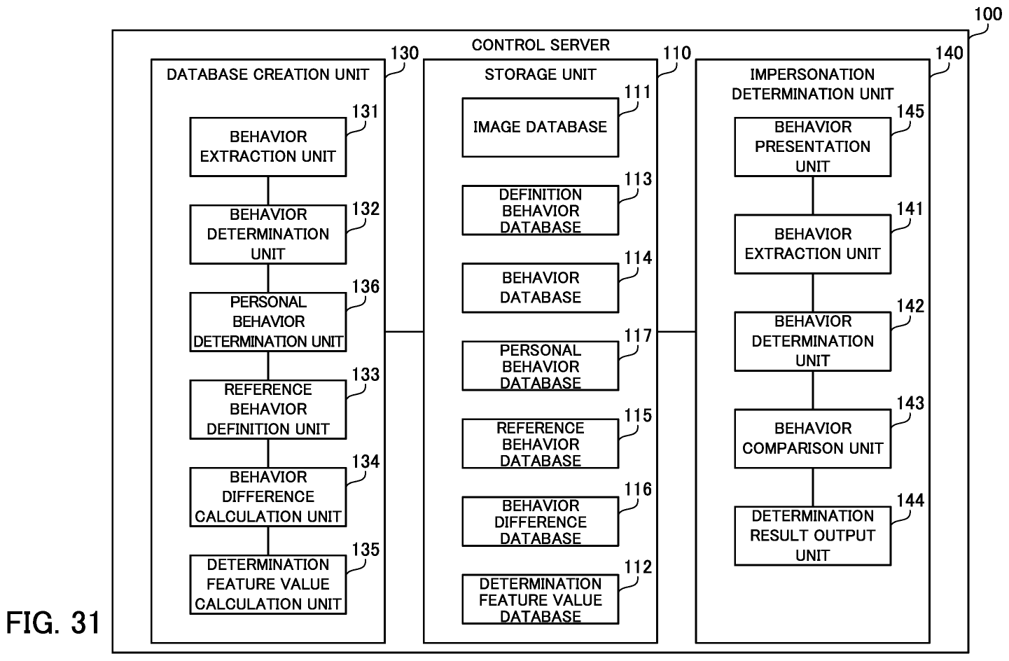

FIG. 31 illustrates a configuration example of a processing function of a control server according to embodiment 2-3. As illustrated in FIG. 31, the impersonation determination unit 140 of the control server 100 according to embodiment 2-3 further includes a behavior presentation unit 145. The behavior presentation unit 145 outputs instruction information that instructs the determination target person to exhibit behaviors of various behavior patterns that are compared by the behavior comparison unit 143 to a communication terminal used by the determination target person performing a communication.

Although FIG. 31 illustrates a configuration in which the behavior presentation unit 145 is added to the impersonation determination unit 140 according to embodiment 2-2 illustrated in FIG. 21, the behavior presentation unit 145 may be added to the impersonation determination unit 140 according to embodiment 2-1 illustrated in FIG. 7.

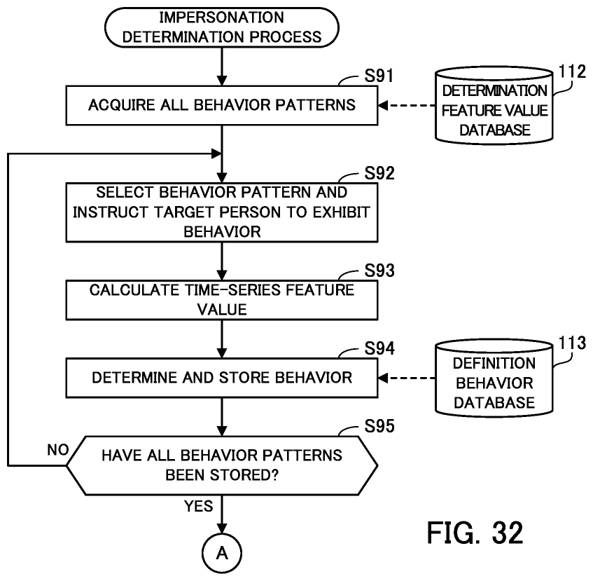

FIG. 32 is an example of a flowchart illustrating a procedure of an impersonation determination process according to embodiment 2-3. In this impersonation determination process according to embodiment 2-3, steps S91 to S95 in FIG. 32 are performed in place of steps S61 to S64 in FIG. 18.

[Step S91] The behavior presentation unit 145 acquires all the behavior pattern IDs associated with the person ID of the determination target person from the determination feature value database 112 (that is, all the behavior pattern IDs of the behavior patterns indicating the characteristic behaviors of the determination target person) In addition, the behavior extraction unit 141 starts to acquire moving image data from the video communication control unit 120.

[Step S92] The behavior presentation unit 145 selects one of the behavior patterns acquired in step S91. The behavior presentation unit 145 transmits instruction information that instructs the determination target person to exhibit a behavior of the selected behavior pattern to the communication terminal from which the moving image data has transmitted. In response to this instruction information, for example, the communication terminal displays an image or outputs a voice to request the determination target person performing the communication to exhibit a behavior of the selected behavior pattern. For example, if the determination target person is requested to exhibit a behavior “tilting head to side”, the communication terminal outputs a voice “Please tilt your head to the side”. The communication terminal may display an image or outputs a voice such that the determination target person will be guided to exhibit the selected behavior. For example, by outputting a question that makes the determination target person exhibit the selected behavior, the communication terminal guides the determination target person to exhibit the selected behavior.

[Step S93] As in steps S12 to S17 in FIG. 8, the behavior extraction unit 141 performs image recognition to extracts a feature value from the individual frame of the entered moving image data and calculates a time-series feature value based on the feature value.

[Step S94] The behavior determination unit 142 compares the calculated time-series feature value with the definition behavior feature values in the definition behavior database 113, so as to detect the behavior that matches any one of the behavior patterns. If the time-series feature value matches the definition behavior feature value about the behavior pattern selected in step S92, the behavior determination unit 142 calculates a behavior feature value corresponding to this behavior pattern based on the time-series feature value and stores the behavior feature value in a storage device (the RAM 102, for example) in association with the corresponding behavior pattern ID.

[Step S95] The behavior presentation unit 145 determines whether the behavior feature values about all the behavior patterns acquired in step S91 have been stored in the storage device. If there are any behavior patterns of behavior feature values that have not been stored, the process returns to step S92, and the behavior presentation unit 145 selects one of these behavior patterns. If all the behavior patterns of behavior feature values have been stored, the process proceeds to step S65 in FIG. 19, and the process using the stored behavior feature values is performed.

According to embodiment 2-3 described above, the behavior presentation unit 145 outputs instruction information that instructs the determination target person to exhibit behaviors of the individual behavior patterns to be compared by the behavior comparison unit 143. Thus, the behavior feature values of the behavior patterns needed for the determination are acquired more reliably. As a result, the impersonation determination accuracy is improved.

In the above second embodiments (embodiments 2-1 to 2-3), “whether the determination target person is the authentic person or not” is determined based on the difference from the characteristic behaviors. However, when the authentic person exhibits abnormal behaviors different from his or her normal behaviors, the difference from his or her characteristic behaviors could also greatly differ. These abnormal behaviors could be seen when the authentic person is sick, blackmailed, or is hiding something, for example. Thus, the above determination process procedure may be used to determine whether a behavior of the authentic person is normal or abnormal. In addition, for example, by using a different determination reference (the threshold in step S69 in FIG. 19) per behavior pattern, it is possible to determine an abnormal type of behavior.

In addition, according to the above second embodiments, image recognition is performed to detect the motions of body parts of a person from the moving image data captured by a communication terminal, and by using the detection result, whether the person is the authentic person is determined. However, for example, voice recognition may be performed to detect conversational habits, reactions, or the like from the voice data picked up by the communication terminal. By combining the detection result with the detection result based on the above moving image data, the process of determining whether the person is the authentic person may be performed.

In addition, a determination result obtained by the process according to any one of the second embodiments may be combined with a determination result obtained by an existing process of detecting a fake face image from moving image data, and a final determination result indicating whether the person is the authentic person may be outputted.

In addition, in the individual second embodiment described above, the determination process is performed in real time by using moving image data from a communication terminal performing a communication. However, alternatively, moving image data of a determination target may be stored in advance in a storage device, and the above determination process may be performed on the moving image data acquired from the storage device.

The processing functions of the apparatuses (for example, the determination apparatus 1 and the control server 100) described in the above embodiments may each be implemented by a computer. In this case, a program in which the processing content of the function of any one of the apparatuses is written is provided, and by causing a computer to execute this program, the above processing function is implemented on the computer. The program in which the processing content is written may be stored in a computer-readable recording medium. Examples of the computer-readable recording medium include a magnetic storage device, an optical disc, and a semiconductor memory. Examples of the magnetic storage device include a hard disk device (HDD) and a magnetic tape. Examples of the optical disc include a compact disc (CD), a digital versatile disc (DVD), and a Blu-ray Disc (BD) (registered trademark).

For example, one way to distribute the program is to sell portable storage media such as DVDs or CDs in which the program is stored. As another example, the program may be stored in a storage device of a server computer and may be forwarded to other computers from the server computer via a network.

For example, a computer that executes the program stores the program recorded in a portable storage medium or forwarded from the server computer in its storage device. Next, the computer reads the program from its storage device and executes processes in accordance with the program. The computer may directly read the program from the portable storage medium and perform processes in accordance with the program. Alternatively, each time a computer receives a program from the server computer connected thereto via the network, the computer may perform processes in accordance with the received program sequentially.

In one aspect, whether a person on an image is authentic is determined accurately.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
calculating, based on a first data group in which data indicating a plurality of types of behaviors of each of a plurality of people is registered, reference behavior data indicating a reference behavior among the plurality of people about each of the plurality of types of behaviors;
acquiring, from the first data group, first behavior data indicating a behavior of a first person among the plurality of people about the each of the plurality of types;
calculating a difference between the first behavior data and the reference behavior data about the each of the plurality of types;
determining, from the plurality of types, at least one first type which has the difference equal to or greater than a first threshold and registering second behavior data indicating a behavior of the first person about each of the at least one first type in a second data group;
extracting third behavior data indicating a behavior of a second person from an input image; and
determining whether the second person is identical with the first person based on a result of a comparison between the third behavior data and the second behavior data.

2. The non-transitory computer-readable recording medium according to claim 1, wherein
the first behavior data is acquired in plurality about the each of the plurality of types of behaviors,
the process further includes determining, from the plurality of types, at least one second type whose variation range among the first behavior data acquired in plurality is equal to or less than a second threshold, and
the at least one first type is determined from the at least one second type.

3. The non-transitory computer-readable recording medium according to claim 1, wherein
the reference behavior data about one type of the plurality of types is calculated as an intermediate value or an average value of data that is registered in the first data group and indicates the one type of behavior of the each of the plurality of people.

4. The non-transitory computer-readable recording medium according to claim 1, wherein the determining of whether the second person is identical with the first person includes determining that the second person is different from the first person when no behavior of the at least one first type is detected from the input image.

5. The non-transitory computer-readable recording medium according to claim 1, wherein
the process further includes outputting instruction information that instructs the second person to exhibit a behavior of the at least one first type, and
the third behavior data is extracted from the input image that is captured after the outputting of the instruction information.

6. A determination method comprising:
calculating, by a first processor, based on a first data group in which data indicating a plurality of types of behaviors of each of a plurality of people is registered, reference behavior data indicating a reference behavior among the plurality of people about each of the plurality of types of behaviors;
acquiring, by the first processor, from the first data group, first behavior data indicating a behavior of a first person among the plurality of people about the each of the plurality of types;
calculating, by the first processor, a difference between the first behavior data and the reference behavior data about the each of the plurality of types;
determining, by the first processor, from the plurality of types, at least one first type which has the difference equal to or greater than a predetermined threshold and registering second behavior data indicating a behavior of the first person about each of the at least one first type in a second data group;
extracting, by the first processor or a second processor, third behavior data indicating a behavior of a second person from an input image; and
determining, by the first processor or the second processor, whether the second person is identical with the first person based on a result of a comparison between the third behavior data and the second behavior data registered in the second data group.

7. A determination apparatus comprising:
a memory; and
a processor coupled to the memory and the processor configured to:
calculate, based on a first data group in which data indicating a plurality of types of behaviors of each of a plurality of people is registered, reference behavior data indicating a reference behavior among the plurality of people about each of the plurality of types of behaviors;
acquire, from the first data group, first behavior data indicating a behavior of a first person among the plurality of people about the each of the plurality of types;
calculate a difference between the first behavior data and the reference behavior data about the each of the plurality of types;
determine, from the plurality of types, at least one first type which has the difference equal to or greater than a first threshold and registering second behavior data indicating a behavior of the first person about each of the at least one first type in a second data group;
extract third behavior data indicating a behavior of a second person from an input image; and
determine whether the second person is identical with the first person based on a result of a comparison between the third behavior data and the second behavior data.
